(19) United States
(12) Patent Application Publication
(10) Pub. No.: US 2012/0140885 A1
(43) Pub. Date: Jun. 7, 2012

(54) RADIOLOGICAL IMAGE DETECTION APPARATUS, RADIOGRAPHIC APPARATUS AND RADIOGRAPHIC SYSTEM

(75) Inventors: Naoto IWAKIRI, Kanagawa (JP); Masaru SATO, Kanagawa (JP)

(73) Assignee: FUJIFILM CORPORATION, Tokyo (JP)

(21) Appl. No.: 13/307,810

(22) Filed: Nov. 30, 2011

(30) Foreign Application Priority Data
Dec. 2, 2010 (JP) 2010-269820

(51) Int. Cl. G01N 23/04

(52) U.S. Cl. 378/62

(57) ABSTRACT

A radiological image detection apparatus includes first and second gratings, a scanning unit, a radiological image detector, a shutter and a shutter driving unit. The second grating includes a period which substantially coincides with a pattern period of a radiological image formed by the radiation passing through the first grating. The scanning unit relatively displaces the radiological image and the second grating to relative positions where phase differences between the radiological image and the second grating are different from each other. The radiological image detector detects the radiological image masked by the second grating. The shutter is in a light path of the radiation toward the first grating. The shutter driving unit opens and closes the shutter. The scanning unit displaces one of the first and second gratings relatively to the other only when the shutter is closed to shield the radiation.

### CROSS-REFERENCE TO RELATED APPLICATIONS

This application claims the benefit of Japanese Patent Application No. 2010-269820, filed on Dec. 2, 2010, the entire contents of which are hereby incorporated by reference, the same as if set forth at length; the entire of which are incorporated herein by reference.

### BACKGROUND OF THE INVENTION

1. Technical Field

The invention relates to a radiological image detection apparatus, a radiographic apparatus and a radiographic system.

2. Description of Related Art

Since X-ray attenuates depending on an atomic number of an element configuring a material and a density and a thickness of the material, it is used as a probe for seeing through an inside of a photographic subject. An imaging using the X-ray is widely spread in fields of medical diagnosis, nondestructive inspection and the like.

In a general X-ray imaging system, a photographic subject is arranged between an X-ray source that irradiates the X-ray and an X-ray image detector that detects the X-ray, and a transmission image of the photographic subject is captured. In this case, the X-ray irradiated from the X-ray source toward the X-ray image detector is subject to the quantity attenuation (absorption) depending on differences of the material properties (for example, atomic numbers, densities and thickness) existing on a path to the X-ray image detector and is then incident onto each pixel of the X-ray image detector. As a result, an X-ray absorption image of the photographic subject is detected and captured by the X-ray image detector. As the X-ray image detector, a flat panel detector (FPD) that uses a semiconductor circuit is widely used in addition to a combination of an X-ray intensifying screen and a film and a photostimulable phosphor.

However, the smaller the atomic number of the element configuring material, the X-ray absorption ability is reduced. Accordingly, for the soft biological tissue or soft material, it is not possible to acquire the contrast of an image that is enough for the X-ray absorption image. For example, the cartilaginous part and joint fluid configuring an articulation of the body are mostly comprised of water. Thus, since a difference of the X-ray absorption amounts thereof is small, it is difficult to obtain the shading difference. Up to date, the soft tissue can be imaged by using the MRI (Magnetic Resonance Imaging). However, it takes several tens of minutes to perform the imaging and the resolution of the image is low such as about 1 mm. Hence, it is difficult to use the MRI in a regular physical examination such as medical checkup due to the cost-effectiveness.

Regarding the above problems, instead of the intensity change of the X-ray by the photographic subject, a research on an X-ray phase imaging of obtaining an image (hereinafter, referred to as a phase contrast image) based on a phase change (refraction angle change) of the X-ray by the photographic subject has been actively carried out in recent years. In general, it has been known that when the X-ray is incident onto an object, the phase of the X-ray, rather than the intensity of the X-ray, shows the higher interaction. Accordingly, in the X-ray phase imaging of using the phase difference, it is possible to obtain a high contrast image even for a weak absorption material having a low X-ray absorption ability. Up to date, regarding the X-ray phase imaging, it has been possible to perform the imaging by generating the X-ray having a wavelength and a phase with a large-scaled synchrotron radiation facility (for example, SPring-8) using an accelerator, and the like. However, since the facility is too huge, it cannot be used in a usual hospital. As the X-ray phase imaging to solve the above problem, an X-ray imaging system has been recently suggested which uses an X-ray Talbot interferometer having two transmission diffraction gratings (phase type grating and absorption type grating) and an X-ray image detector (for example, refer to JP-2008-200359-A).

The X-ray Talbot interferometer includes a first diffraction grating G1 (phase type grating or absorption type grating) that is arranged at a rear side of a photographic subject, a second diffraction grating G2 (absorption type grating) that is arranged downstream at a specific distance (Talbot interference distance) determined by a grating pitch of the first diffraction grating and an X-ray wavelength, and an X-ray image detector that is arranged at a rear side of the second diffraction grating. The Talbot interference distance is a distance in which the X-ray having passed through the first diffraction grating G1 forms a self-image by the Talbot interference effect. The self-image is modulated by the interaction (phase change) of the photographic subject, which is arranged between the X-ray source and the first diffraction grating, and the X-ray.

In the X-ray Talbot interferometer, a moiré fringe that is generated by superposition between the self-image of the first diffraction grating G1 and the second diffraction grating G2 is detected and a change of the moiré fringe by the photographic subject is analyzed, so that phase information of the photographic subject is acquired. As the analysis method of the moiré fringe, a fringe scanning method has been known, for example. According to the fringe scanning method, a plurality of imaging is performed while the second diffraction grating G2 is translation-moved with respect to the first diffraction grating G1 in a direction, which is substantially parallel with a plane of the first diffraction grating G1 and is substantially perpendicular to a grating direction (strip band direction) of the first diffraction grating G1, with a scanning pitch that is obtained by equally partitioning the grating pitch. Then, an angle distribution (differential image of a phase shift) of the X-ray refracted at the photographic subject is acquired from changes of signal values of respective pixels obtained in the X-ray image detector. Based on the acquired angle distribution, it is possible to obtain a phase contrast image of the photographic subject.

According to the phase contrast image that is obtained as described above, it is possible to capture an image of the tissue (cartilage, soft part) that cannot be imaged because the absorption difference is too small and thus the contrast difference is little according to the conventional imaging method based on the X-ray absorption. In particular, while the absorption difference is little obtained between the cartilage and the joint fluid according to the X-ray absorption method, a clear contrast is made according to the X-ray phase (refraction) imaging, so that an image thereof can be captured. Thereby, it is possible to rapidly and easily diagnose the knee osteoarthritis that most of the aged (about 30 million persons) are regarded to have, the arthritic disease such as meniscus injury due to sports disorders, the rheumatism, the Achilles tendon injury, the disc hernia and the soft tissue such as breast tumor mass by the X-ray. Hence, it is expected that it is possible to contribute to the early diagnosis and the early treatment of the potential patient and the reduction of the medical care cost.

The X-ray phase (refraction) imaging is to perform a plurality of imaging while stepwise moving the second diffraction grating G2 and to restore the phase of the X-ray incident onto the respective pixels from a plurality of intensity values for the respective pixels, which are obtained from the respective captured images, thereby forming a phase contrast image.

Thus, according to the X-ray imaging system of JP-2008-200359-A, when stopping the irradiation of the X-ray every imaging, the power supply to an X-ray tube is stopped. However, since there is a time constant occurring next time in the X-ray system, the power is continuously supplied for a while even after the power supply is stopped, so that it is not possible to immediately stop the X-ray. That is, a remaining output (which is also referred to as wave tail) exists for some while in the output of the X-ray tube.

When a tube current flowing to the X-ray tube is I and a tube voltage is V, an apparent resistance R of the X-ray tube is expressed by R=V/I. Also, when a capacity of the X-ray tube is C_{Tube}[pF], a capacity of an X-ray cable is Cₗᵢₙₑ[pF/m] and a cable length is L, a capacity C of the X-ray system can be obtained by C=C_{Tube}+Cₗᵢₙₑ×L. In this case, the time constant t of the X-ray system can be obtained by τ=RC.

For example, in order to obtain the contrast of the soft tissue, when the tube voltage is set as 50 kV and the tube current is set as 50 mA, the resistance R is 1×10⁶. Also, when the capacity C_{Tube} of the X-ray tube is about 500 to 1500 pF, representatively 500 pF, the capacity Cₗᵢₙₑ of the X-ray cable is about 100 to 200 pF, representatively 150 pF/m, and the cable length is set as 20 m, the capacity C of the X-ray system is 3,500 pF. Therefore, the time constant τ is 3.5 msec and the time of the wave tail is several tens of ms when it is set to be three to five times than the time constant τ, as the sufficient attenuation time of the X-ray.

When performing a plurality of imaging with respect to the X-ray phase (refraction) imaging, the imaging should be performed in a short time because a patient cannot typically keep still for a long time due to the diseases. Accordingly, in order to perform the imaging at a rate of 2 to 30 images per second, it is necessary that the irradiation time of the X-ray should be 20 msec or shorter. In this case, even when the irradiation time is 20 msec or shorter, if the wave tail exists for several tens of ms, a ratio of the time of the wave tail to the entire irradiation time is not negligible. When the second diffraction grating G2 is driven in a time zone in which the X-ray by the wave tail is generated, a distance between the first diffraction grating G1 and the second diffraction grating G2 is changed by the moving of the second diffraction grating G2, so that a moiré fringe is varied. The variation of the moiré fringe is superimposed on the pattern of the original moiré fringe by the phase difference/refractive index difference, so that a calculation error is caused when reconstructing an image of the phase difference/refractive index difference after performing the imaging.

Accordingly, when generating a phase contrast image, the contrast or resolution is lowered and the artifact in which the variation of the moiré fringe cannot be perfectly removed is generated, so that the diagnosis ability is remarkably deteriorated. Also, when the imaging is not performed until the wave tail naturally converges, it takes much time to complete the plurality of imaging, so that the shaking due to the moving of the patient is also caused. Also, regarding the moving of the second diffraction grating G2, since the moving speed of the second diffraction grating G2 is exceedingly responsive at the time of rising, the moving speed is not the constant speed. If the X-ray by the wave tail is generated when the moving speed is excessive, the component by the corresponding influence is also superimposed on the image, so that the pattern of the stable moiré fringe cannot be obtained. In addition, the position deviation of the X-ray due to the change of the phase shift/refractive index, which is caused when the X-ray penetrates the photographic subject, is slight such as about 1 μm and a little variation of the intensity value also highly influences the phase restoring accuracy.

Like this, the influence of the wave tail on the X-ray phase (refraction) imaging is much higher, compared to the typical still image of the X-ray or moving picture imaging in which images are not reconstructed by calculation from the slight changes of the images. Also, even compared to the technique of capturing a plurality of images while changing the incident angle of the X-ray onto the photographic subject and then reconstructing the images, such as CT or Tomosynthesis, the above influence is very high. The reason is as follows. When capturing the phase contrast image, the slight position deviation of the X-ray such as about 1 μm, which is caused due to the phase shift/refractive index change of the X-ray, is captured as the moiré while moving the grating without changing the incident angle of the X-ray onto the photographic subject. However, the image itself of the photographic subject is little changed. Accordingly, even compared to the image capturing of performing the reconstruction such as CT or Tomosynthesis, the influence of the wave tail on the slight image change is high.

The invention has been made to solve the above problems. An object of the invention is to remove an influence of a wave tail of a tube voltage waveform and to thus improve a quality of a radiological phase contrast image when performing a phase imaging by radiation such as X-ray.

### SUMMARY

A radiological image detection apparatus includes a first grating, a second grating, a scanning unit, a radiological image detector, a shutter and a shutter driving unit. The second grating includes a period which substantially coincides with a pattern period of a radiological image formed by the radiation passing through the first grating. The scanning unit relatively displaces the radiological image and the second grating to a plurality of relative positions at which phase differences between the radiological image and the second grating are different from each other. The radiological image detector detects the radiological image masked by the second grating. The shutter is provided in a middle of a light path of the radiation toward the first grating. The shutter driving unit opens and closes the shutter. The scanning unit displaces at least one of the first grating and the second grating relatively to the other only in a period during which the shutter is closed to shield the radiation to be irradiated to the first grating.

According to the invention, it is possible to remove an influence of a wave tail of a tube voltage waveform and to thus improve a quality of a radiological phase contrast image when performing a phase imaging by radiation such as X-ray.

### BRIEF DESCRIPTION OF THE DRAWINGS

FIG. 1 is a pictorial view showing an example of a configuration of a radiographic system for illustrating an illustrative embodiment of the invention.

FIG. 2 is a control block diagram of the radiographic system of FIG. 1.

FIG. 3 is a pictorial view showing a configuration of a radiological image detector of the radiographic system of FIG. 1.

FIG. 4 is a perspective view of an imaging unit of the radiographic system of FIG. 1.

FIG. 5 is a side view of the imaging unit of the radiographic system of FIG. 1.

FIGS. 6A, 6B and 6C are pictorial views showing a mechanism for changing a period of a moiré fringe resulting from superposition of first and second gratings.

FIG. 7 is a pictorial view for illustrating refraction of radiation by a photographic subject.

FIG. 8 is a pictorial view for illustrating a fringe scanning method.

FIG. 9 is a graph showing pixel signals of the radiological image detector in accordance with the fringe scanning.

FIG. 10 shows a schematic configuration of a shutter unit and the imaging unit.

FIG. 11 illustrates a relation of a waveform of a tube voltage that is applied to an X-ray source, an opening and closing timing of the shutter unit and a moving amount of a grating by a scanning mechanism.

FIG. 12 illustrates a relation of a waveform of a tube voltage that is applied to the X-ray source when the X-ray is continuously irradiated, an opening and closing timing of the shutter unit and a moving amount of a grating by a scanning mechanism.

FIG. 13 shows a schematic configuration of the shutter unit and the imaging unit.

FIG. 14 is a pictorial view showing another example of a configuration of a radiographic system for illustrating an illustrative embodiment of the invention.

FIG. 15 is a pictorial view showing a configuration of a modified embodiment of the radiographic system of FIG. 14.

FIG. 16 is a pictorial view showing another example of a configuration of a radiographic system for illustrating an illustrative embodiment of the invention.

FIG. 17 shows a schematic configuration of a shutter unit that is disposed in a collimator unit.

FIG. 18 is a block diagram showing a configuration of a calculation unit that generates a radiological image, in accordance with another example of a radiographic system for illustrating an illustrative embodiment of the invention.

FIG. 19 is a graph showing pixel signals of the radiological image detector for illustrating a process in the calculation unit of the radiographic system shown in FIG. 18.

### DETAILED DESCRIPTION OF EMBODIMENTS OF THE INVENTION

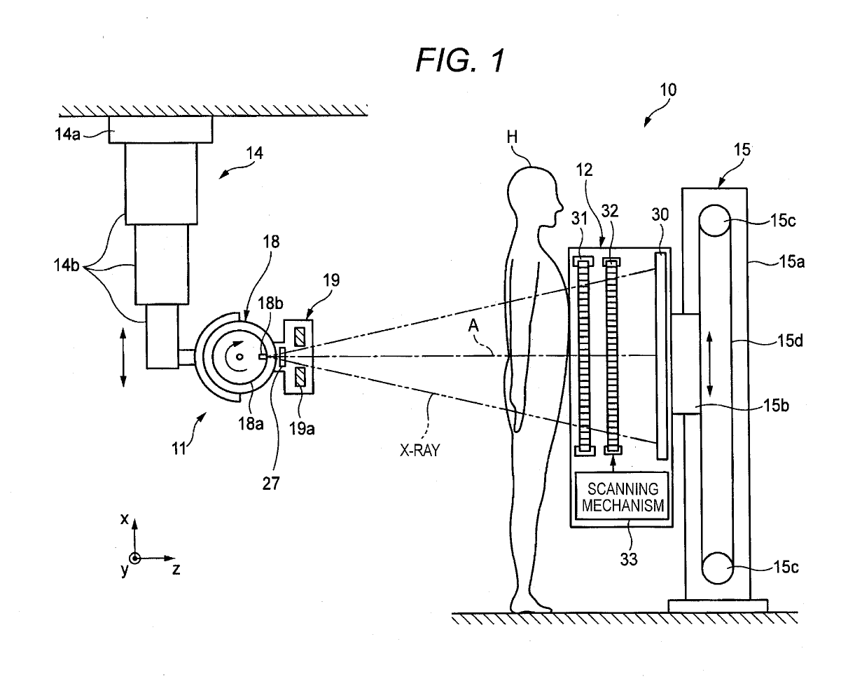

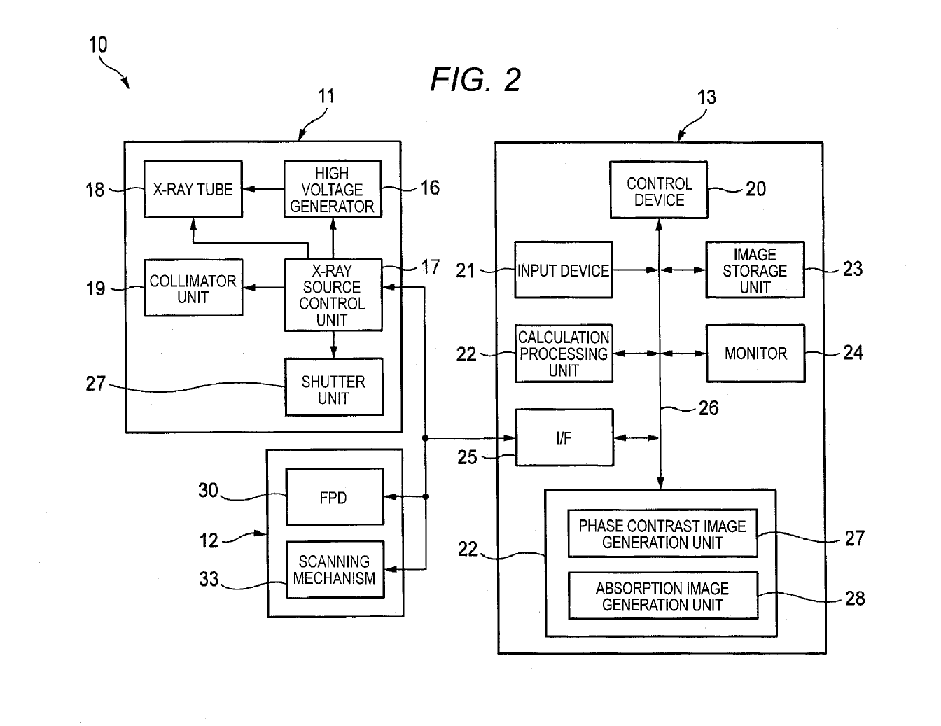

FIG. 1 shows an example of a configuration of a radiographic system for illustrating an illustrative embodiment of the invention and FIG. 2 is a control block diagram of the radiographic system of FIG. 1.

An X-ray imaging system 10 is an X-ray diagnosis apparatus that performs an imaging for a photographic subject (patient) H while the patient stands, and includes an X-ray source 11 that X-radiates the photographic subject H, an imaging unit 12 that is opposed to the X-ray source 11, detects the X-ray having penetrated the photographic subject H from the X-ray source 11 and thus generates image data and a console 13 that controls an exposing operation of the X-ray source 11 and an imaging operation of the imaging unit 12 based on an operation of an operator, calculates the image data acquired by the imaging unit 12 and thus generates a phase contrast image.

The X-ray source 11 is held so that it can be moved in an upper-lower direction (x direction) by an X-ray source holding device 14 hanging from the ceiling. The imaging unit 12 is held that it can be moved in the upper-lower direction by an upright stand 15 mounted on the bottom.

The X-ray source 11 includes an X-ray tube 18 that generates the X-ray in response to a high voltage applied from a high voltage generator 16, based on control of an X-ray source control unit 17, and a collimator unit 19 having a moveable collimator 19a that limits an irradiation field so as to shield a part of the X-ray generated from the X-ray tube 18, which part does not contribute to an inspection area of the photographic subject H. The X-ray tube 18 is a rotary anode type that emits an electron beam from a filament (not shown) serving as an electron emission source (cathode) and collides the electron beam with a rotary anode 18a being rotating at predetermined speed, thereby generating the X-ray. A collision part of the electron beam of the rotary anode 18a is an X-ray focus point 18b.

Also, a shutter unit 27 is accommodated in the collimator unit 19. As specifically described in the below, the shutter unit 27 has a shutter that is provided in the middle of a light path of the radiation toward the imaging unit 12 and a shutter driving unit that opens and closes the shutter.

The X-ray source holding device 14 includes a carriage unit 14a that is adapted to move in a horizontal direction (z direction) by a ceiling rail (not shown) mounted on the ceil and a plurality of strut units 14b that is connected in the upper-lower direction. The carriage unit 14a is provided with a motor (not shown) that expands and contracts the strut units 14b to change a position of the X-ray source 11 in the upper-lower direction.

The upright stand 15 includes a main body 15a that is mounted on the bottom and a holding unit 15b that holds the imaging unit 12 and is attached to the main body 15a so as to move in the upper-lower direction. The holding unit 15b is connected to an endless belt 15d that extends between two pulleys 16c spaced in the upper-lower direction, and is driven by a motor (not shown) that rotates the pulleys 15c. The driving of the motor is controlled by a control device 20 of the console 13 (which will be described later), based on a setting operation of the operator.

Also, the upright stand 15 is provided with a position sensor (not shown) such as potentiometer, which measures a moving amount of the pulleys 15c or endless belt 15d and thus detects a position of the imaging unit 12 in the upper-lower direction. The detected value of the position sensor is supplied to the X-ray source holding device 14 through a cable and the like. The X-ray source holding device 14 expands and contracts the struts 14b, based on the detected value, and thus moves the X-ray source 11 to follow the vertical moving of the imaging unit 12.

The console 13 is provided with the control device 20 that includes a CPU, a ROM, a RAM and the like. The control device 20 is connected with an input device 21 with which the operator inputs an imaging instruction and an instruction content thereof, a calculation processing unit 22 that calculates the image data acquired by the imaging unit 12 and thus generates an X-ray image, a storage unit 23 that stores the X-ray image, a monitor 24 that displays the X-ray image and the like and an interface (I/F) 25 that is connected to the respective units of the X-ray imaging system 10, via a bus 26.

As the input device 21, a switch, a touch panel, a mouse, a keyboard and the like may be used, for example. By operating the input device 21, radiography conditions such as X-ray tube voltage, X-ray irradiation time and the like, an imaging timing and the like are input. The monitor 24 consists of a liquid crystal display and the like and displays letters such as radiography conditions and the X-ray image under control of the control device 20.

The imaging unit 12 has a flat panel detector (FPD) 30 that has a semiconductor circuit, and a first absorption type grating 31 and a second absorption type grating 32 that detect a phase change (angle change) of the X-ray by the photographic subject H and perform a phase imaging.

The FPD 30 has a detection surface that is arranged to be orthogonal to the optical axis A of the X-ray irradiated from the X-ray source 11. As specifically described in the below, the first and second absorption type gratings 31, 32 are arranged between the FPD 30 and the X-ray source 11.

Also, the imaging unit 12 is provided with a scanning mechanism 33 that translation-moves the second absorption type grating 32 in the upper-lower (x direction) and thus changes a relative position relation of the second absorption type grating 32 to the first absorption type grating 31. The scanning mechanism 33 consists of an actuator such as piezoelectric device, for example.

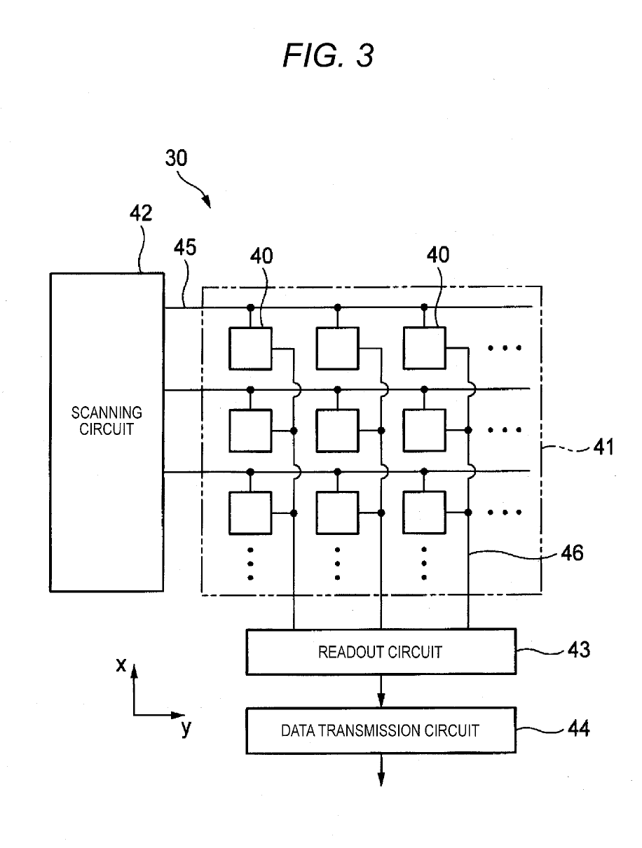

FIG. 3 shows a configuration of the radiological image detector that is included in the radiographic system of FIG. 1.

The FPD 30 serving as the radiological image detector includes an image receiving unit 41 having a plurality of pixels 40 that converts and accumulates the X-ray into charges and is two-dimensionally arranged in the xy directions on an active matrix substrate, a scanning circuit 42 that controls a timing of reading out the charges from the image receiving unit 41, a readout circuit 43 that reads out the charges accumulated in the respective pixels 40 and converts and stores the charges into image data and a data transmission circuit 44 that transmits the image data to the calculation processing unit 22 through the I/F 25 of the console 13. Also, the scanning circuit 42 and the respective pixels 40 are connected by scanning lines 45 in each of rows and the readout circuit 43 and the respective pixels 40 are connected by signal lines 46 in each of columns.

Each pixel 40 can be configured as a direct conversion type element that directly converts the X-ray into charges with a conversion layer (not shown) made of amorphous selenium and the like and accumulates the converted charges in a capacitor (not shown) connected to a lower electrode of the conversion layer. Each pixel 40 is connected with a TFT switch (not shown) and a gate electrode of the TFT switch is connected to the scanning line 45, a source electrode is connected to the capacitor and a drain electrode is connected to the signal line 46. When the TFT switch turns on by a driving pulse from the scanning circuit 42, the charges accumulated in the capacitor are read out to the signal line 46.

Meanwhile, each pixel 40 may be also configured as an indirect conversion type X-ray detection element that converts the X-ray into visible light with a scintillator (not shown) made of terbium-doped gadolinium oxysulfide (Gd₂O₂S:Tb), thallium-doped cesium iodide (CsI:Tl) and the like and then converts and accumulates the converted visible light into charges with a photodiode (not shown). Also, the X-ray image detector is not limited to the FPD based on the TFT panel. For example, a variety of X-ray image detectors based on a solid imaging device such as CCD sensor, CMOS sensor and the like may be also used.

The readout circuit 43 includes an integral amplification circuit, an A/D converter, a correction circuit and an image memory, which are not shown. The integral amplification circuit integrates and converts the charges output from the respective pixels 40 through the signal lines 46 into voltage signals (image signals) and inputs the same into the A/D converter. The A/D converter converts the input image signals into digital image data and inputs the same to the correction circuit. The correction circuit performs an offset correction, a gain correction and a linearity correction for the image data and stores the image data after the corrections in the image memory. Meanwhile, the correction process of the correction circuit may include a correction of an exposure amount and an exposure distribution (so-called shading) of the X-ray, a correction of a pattern noise (for example, a leak signal of the TFT switch) depending on control conditions (driving frequency, readout period and the like) of the FPD 30, and the like.

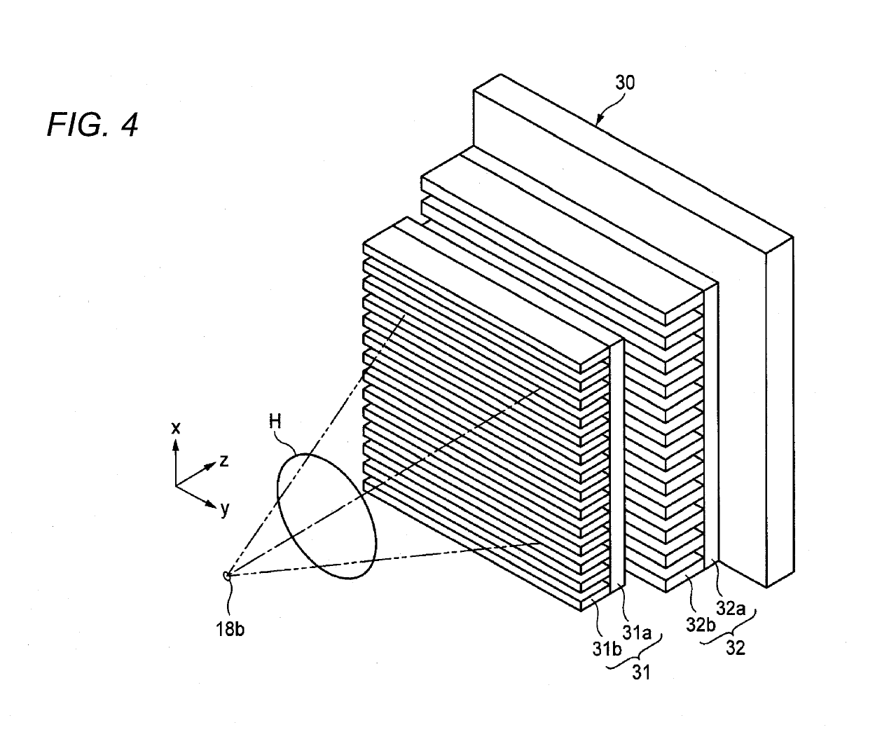

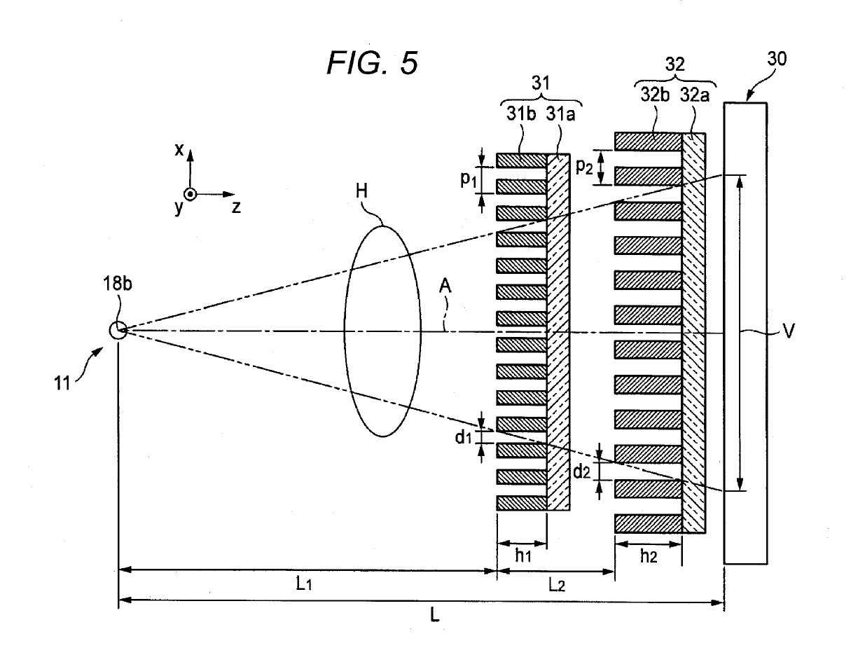

FIGS. 4 and 5 show the imaging unit of the radiographic system of FIG. 1.

The first absorption type grating 31 has a X-ray transmission unit (a substrate) 31a and a plurality of X-ray shield units 31b arranged on the X-ray transmission unit 31a. Likewise, the second absorption type grating 32 has a X-ray transmission unit (a substrate) 32a and a plurality of X-ray shield units 32b arranged on the X-ray transmission unit 32a. The X-ray transmission units 31a, 32a are configured by radiolucent members through which the X-ray penetrates, such as glass.

The X-ray shield units 31b, 32b are configured by linear members extending in in-plane one direction (in the shown example, a y direction orthogonal to the x and z directions) orthogonal to the optical axis A of the X-ray irradiated from the X-ray source 11. As the materials of the respective X-ray shield units 31b, 32b, materials having excellent X-ray absorption ability are preferable. For example, the heavy metal such as gold, platinum and the like is preferable. The X-ray shield units 31b, 32b can be formed by the metal plating or deposition method.

The X-ray shield units 31b are arranged on the in-plane orthogonal to the optical axis A of the X-ray with a constant pitch p₁ and at a predetermined interval d₁ in the direction (x direction) orthogonal to the one direction. Likewise, the X-ray shield units 32b are arranged on the in-plane orthogonal to the optical axis A of the X-ray with a constant pitch p₂ and at a predetermined interval d₂ in the direction (x direction) orthogonal to the one direction. Since the first and second absorption type gratings 31, 32 provide the incident X-ray with an intensity difference, rather than the phase difference, they are also referred to as amplitude type gratings. In the meantime, the slit (area of the interval d₁ or d₂) may not be a void. For example, the void may be filled with X-ray low absorption material such as high molecule or light metal.

The first and second absorption type gratings 31, 32 are adapted to geometrically project the X-ray having passed through the slits, regardless of the Talbot interference effect. Specifically, the intervals d₁, d₂ are set to be sufficiently larger than a peak wavelength of the X-ray irradiated from the X-ray source 11, so that most of the X-ray included in the irradiated X-ray is enabled to pass through the slits while keeping the linearity thereof, without being diffracted in the slits. For example, when the rotary anode 18a is made of tungsten and the tube voltage is 50 kV, the peak wavelength of the X-ray is about 0.4 Å. In this case, when the intervals d₁, d₂ are set to be about 1 to 10 μm, most of the X-ray is geometrically projected in the slits without being diffracted.

Since the X-ray irradiated from the X-ray source 11 is a conical beam having the X-ray focus point 18b as an emitting point, rather than a parallel beam, a projection image (hereinafter, referred to as G1 image), which has passed through the first absorption type grating 31 and is projected, is enlarged in proportion to a distance from the X-ray focus point 18b. The grating pitch p₂ and the interval d₂ of the second absorption type grating 32 are determined so that the slits substantially coincide with a periodic pattern of bright parts of the G1 image at the position of the second absorption type grating 32. That is, when a distance from the X-ray focus point 18b to the first absorption type grating 31 is L₁ and a distance from the first absorption type grating 31 to the second absorption type grating 32 is L₂, the grating pitch p₂ and the interval d₂ are determined to satisfy following equations (1) and (2).

$$\begin{matrix}[ equation 1 ] & \\ {p}_{2} = \frac{{L}_{1} + {L}_{2}}{{L}_{1}} {p}_{1} & ( 1 ) \\ [ equation 2 ] & \\ {d}_{2} = \frac{{L}_{1} + {L}_{2}}{{L}_{1}} {d}_{1} & ( 2 )\end{matrix}$$

In the Talbot interferometer, the distance L₂ from the first absorption type grating 31 to the second absorption type grating 32 is restrained with a Talbot interference distance that is determined by a grating pitch of a first diffraction grating and an X-ray wavelength. However, in the imaging unit 12 of the X-ray imaging system 10 of this illustrative embodiment, since the first absorption type grating 31 projects the incident X-ray without diffracting the same and the G1 image of the first absorption type grating 31 is similarly obtained at all positions of the rear of the first absorption type grating 31, it is possible to set the distance L₂ irrespective of the Talbot interference distance.

Although the imaging unit 12 does not configure the Talbot interferometer, as described above, a Talbot interference distance Z that is obtained if the first absorption type grating 31 diffracts the X-ray is expressed by a following equation (3) using the grating pitch p₁ of the first absorption type grating 31, the grating pitch p₂ of the second absorption type grating 32, the X-ray wavelength (peak wavelength) λ and a positive integer m.

$$\begin{matrix}[ equation 3 ] & \\ Z = m \frac{ {p}_{1} {p}_{2}}{λ} & ( 3 )\end{matrix}$$

The equation (3) indicates a Talbot interference distance when the X-ray irradiated from the X-ray source 11 is a conical beam and is known by Atsushi Momose, et al. (Japanese Journal of Applied Physics, Vol. 47, No. 10, 2008, October, page 8077).

In the X-ray imaging system 10, the distance L₂ is set to be shorter than the minimum Talbot interference distance Z when m=1 so as to make the imaging unit 12 smaller. That is, the distance L₂ is set by a value within a range satisfying a following equation (4).

$$\begin{matrix}[ equation 4 ] & \\ {L}_{2} < \frac{{p}_{1} {p}_{2}}{λ} & ( 4 )\end{matrix}$$

In addition, when the X-ray irradiated from the X-ray source 11 can be considered as a substantially parallel beam, the Talbot interference distance Z is expressed by a following equation (5) and the distance L₂ is set by a value within a range satisfying a following equation (6).

$$\begin{matrix}[ equation 5 ] & \\ Z = m \frac{{p}_{1 }^{2}}{λ} & ( 5 ) \\ [ equation 6 ] & \\ {L}_{2} < \frac{{p}_{1}^{2}}{λ} & ( 6 )\end{matrix}$$

In order to generate a period pattern image having high contrast, it is preferable that the X-ray shield units 31b, 32b perfectly shield (absorb) the X-ray. However, even when the materials (gold, platinum and the like) having excellent X-ray absorption ability are used, many X-rays penetrate the X-ray shield units without being absorbed. Accordingly, in order to improve the shield ability of X-ray, it is preferable to make thickness h₁, h₂ of the X-ray shield units 31b, 32b thicker as much as possible, respectively. For example, when the tube voltage of the X-ray tube 18 is 50 kV, it is preferable to shield 90% or more of the irradiated X-ray. In this case, the thickness h₁, h₂ are preferably 30 μM or larger, based on gold (Au).

In the meantime, when the thickness h₁, h₂ of the X-ray shield units 31b, 32b are excessively thickened, it is difficult for the obliquely incident X-ray to pass through the slits. Thereby, the so-called vignetting occurs, so that an effective field of view of the direction (x direction) orthogonal to the extending direction (strip band direction) of the X-ray shield units 31b, 32b is narrowed. Therefore, from a standpoint of securing the field of view, the upper limits of the thickness h₁, h₂ are defined. In order to secure a length V of the effective field of view in the x direction on the detection surface of the FPD 30, when a distance from the X-ray focus point 18b to the detection surface of the FPD 30 is L, the thickness h₁, h₂ are necessarily set to satisfy following equations (7) and (8), from a geometrical relation shown in FIG. 5.

$$\begin{matrix}[ equation 7 ] & \\ {h}_{1} \leq \frac{L}{V / 2} {d}_{1} & ( 7 ) \\ [ equation 8 ] & \\ {h}_{2} \leq \frac{L}{V / 2} {d}_{2} & ( 8 )\end{matrix}$$

For example, when d₁=2.5 μm, d₂=3.0 μm and L=2 m, assuming a typical diagnose in a typical hospital, the thickness h₁ should be 100 μm or smaller and the thickness h₂ should be 120 μm or smaller so as to secure a length of 10 cm as the length V of the effective field of view in the x direction.

The X-ray shield unit 31b is made of a band-shaped member that extends in the in-plane one direction (in the shown example, y direction) orthogonal to the optical axis A of the X-ray irradiated from the X-ray source 11. As the materials of the X-ray shield unit 31b, materials having excellent X-ray absorption ability are preferable. For example, a metal foil such as lead, copper, tungsten and the like is used. The X-ray shield units 31b are arranged on the in-plane orthogonal to the optical axis A of the X-ray at an interval in the direction (x direction) orthogonal to the one direction. The X-ray transmission units 31a are provided to fill between the neighboring X-ray shield units 31b. As the materials of the X-ray transmission unit 31a, materials having X-ray low absorption ability are preferable. For example, high molecule or light metal is used.

In the imaging unit 12 configured as described above, an intensity-modulated image is formed by the superimposition of the G1 image of the first absorption type grating 31 and the second absorption type grating 32 and is captured by the FPD 30. A pattern period p₁′ of the G1 image at the position of the second absorption type grating 32 and a substantial grating pitch p₂′ (substantial pitch after the manufacturing) of the second absorption type grating 32 are slightly different due to the manufacturing error or arrangement error. The arrangement error means that the substantial pitches of the first and second absorption type gratings 31, 32 in the x direction are changed as the inclination, rotation and the interval therebetween are relatively changed.

Due to the slight difference between the pattern period p₁′ of the G1 image and the grating pitch p₂′, the image contrast becomes a moiré fringe. A period T of the moiré fringe is expressed by a following equation (9).

$$\begin{matrix}[ equation 9 ] & \\ T = \frac{{p}_{1}^{′} \times {p}_{2}^{′}}{\vert {p}_{1}^{′} - {p}_{2}^{′} \vert} & ( 9 )\end{matrix}$$

When it is intended to detect the moiré fringe with the FPD 30, an arrangement pitch P of the pixels 40 in the x direction should satisfy at least a following equation (10) and preferably satisfy a following equation (11) (n: positive integer).

[equation 10]

P≠nT (10)

[equation 11]

P<T (11)

The equation (10) means that the arrangement pitch P is not an integer multiple of the moiré period T. Even for a case of n≧2, it is possible to detect the moiré fringe in principle. The equation (11) means that the arrangement pitch P is set to be smaller than the moiré period T.

Since the arrangement pitch P of the pixels 40 of the FPD 30 are design-determined (in general, about 100 μm) and it is difficult to change the same, when it is intended to adjust a magnitude relation of the arrangement pitch P and the moiré period T, it is preferable to adjust the positions of the first and second absorption type gratings 31, 32 and to change at least one of the pattern period p₁′ of the G1 image and the grating pitch p₂′, thereby changing the moiré period T.

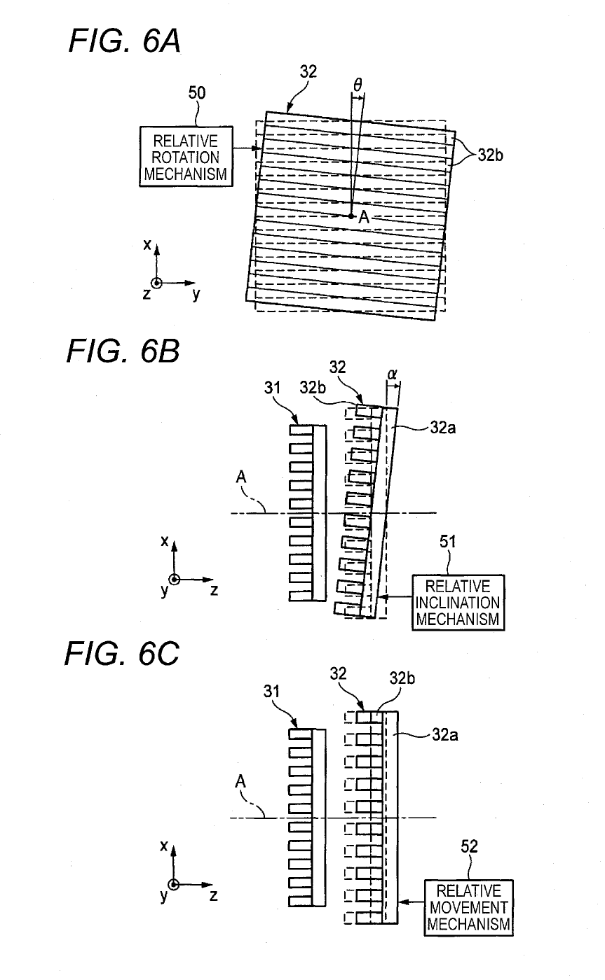

FIGS. 6A, 6B and 6C show methods of changing the moiré period T.

It is possible to change the moiré period T by relatively rotating one of the first and second absorption type gratings 31, 32 about the optical axis A. For example, there is provided a relative rotation mechanism 50 that rotates the second absorption type grating 32 relatively to the first absorption type grating 31 about the optical axis A. When the second absorption type grating 32 is rotated by an angle θ by the relative rotation mechanism 50, the substantial grating pitch in the x direction is changed from “p₂′” to “p₂′/cos θ”, so that the moiré period T is changed (refer to FIG. 6A).

As another example, it is possible to change the moiré period T by relatively inclining one of the first and second absorption type gratings 31, 32 about an axis orthogonal to the optical axis A and following the y direction. For example, there is provided a relative inclination mechanism 51 that inclines the second absorption type grating 32 relatively to the first absorption type grating 31 about an axis orthogonal to the optical axis A and following the y direction. When the second absorption type grating 32 is inclined by an angle α by the relative inclination mechanism 51, the substantial grating pitch in the x direction is changed from “p₂′” to “p₂′×cos α”, so that the moiré period T is changed (refer to FIG. 6B).

As another example, it is possible to change the moiré period T by relatively moving one of the first and second absorption type gratings 31, 32 along a direction of the optical axis A. For example, there is provided a relative movement mechanism 52 that moves the second absorption type grating 32 relatively to the first absorption type grating 31 along a direction of the optical axis A so as to change the distance L₂ between the first absorption type grating 31 and the second absorption type grating 32. When the second absorption type grating 32 is moved along the optical axis A by a moving amount δ by the relative movement mechanism 52, the pattern period of the G1 image of the first absorption type grating 31 projected at the position of the second absorption type grating 32 is changed from “p₁′” to “p₁′×(L₁+L₂+δ)/(L₁+L₂)”, so that the moiré period T is changed (refer to FIG. 6C).

In the X-ray imaging system 10, since the imaging unit 12 is not the Talbot interferometer and can freely set the distance L₂, it can appropriately adopt the mechanism for changing the distance L₂ to thus change the moiré period T, such as the relative movement mechanism 52. The changing mechanisms (the relative rotation mechanism 50, the relative inclination mechanism 51 and the relative movement mechanism 52) of the first and second absorption type gratings 31, 32 for changing the moiré period T can be configured by actuators such as piezoelectric devices.

When the photographic subject H is arranged between the X-ray source 11 and the first absorption type grating 31, the moiré fringe that is detected by the FPD 30 is modulated by the photographic subject H. An amount of the modulation is proportional to the angle of the X-ray that is deviated by the refraction effect of the photographic subject H. Accordingly, it is possible to generate the phase contrast image of the photographic subject H by analyzing the moiré fringe detected by the FPD 30.

In the below, an analysis method of the moiré fringe is described.

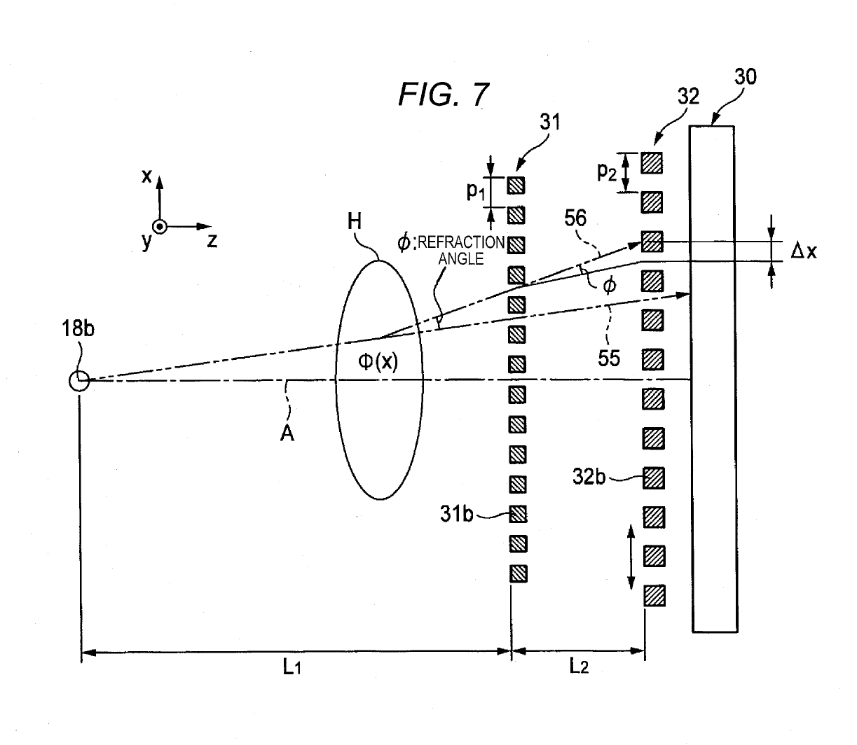

FIG. 7 shows one X-ray that is refracted in correspondence to a phase shift distribution Φ(x) in the x direction of the photographic subject H. In the meantime, a scattering removing grating is not shown.

A reference numeral 55 indicates a path of the X-ray that goes straight when there is no photographic subject H. The X-ray traveling along the path 55 passes through the first and second absorption type gratings 31, 32 and is then incident onto the FPD 30. A reference numeral 56 indicates a path of the X-ray that is refracted and deviated by the photographic subject H. The X-ray traveling along the path 56 passes through the first absorption type grating 31 and is then shielded by the second absorption type grating 32.

The phase shift distribution Φ(x) of the photographic subject H is expressed by a following equation (12), when a refractive index distribution of the photographic subject H is indicated by n(x, z) and the traveling direction of the X-ray is indicated by z.

$$\begin{matrix}[ equation 12 ] & \\ Φ ( x ) = \frac{2 π}{λ} \int [ 1 - n ( x , z ) ] d z & ( 12 )\end{matrix}$$

The G1 image that is projected from the first absorption type grating 31 to the position of the second absorption type grating 32 is displaced in the x direction as an amount corresponding to a refraction angle φ, due to the refraction of the X-ray at the photographic subject H. An amount of displacement Δx is approximately expressed by a following equation (13), based on the fact that the refraction angle φ of the X-ray is slight.

[equation 13]

Δx≈L₂φ (13)

Here, the refraction angle φ is expressed by an equation (14) using a wavelength λ of the X-ray and the phase shift distribution Φ(x) of the photographic subject H.

$$\begin{matrix}[ equation 14 ] & \\ ϕ = \frac{λ}{2 π} \frac{\partial Φ ( x )}{\partial x} & ( 14 )\end{matrix}$$

Like this, the amount of displacement Δx of the G1 image due to the refraction of the X-ray at the photographic subject H is related to the phase shift distribution Φ(x) of the photographic subject H. Also, the amount of displacement Δx is related to a phase deviation amount ψ of a signal output from each pixel 40 of the FPD 40 (a deviation amount of a phase of a signal of each pixel 40 when there is the photographic subject H and when there is no photographic subject H), as expressed by a following equation (15).

$$\begin{matrix}[ equation 15 ] & \\ Ψ = \frac{2 n}{{p}_{2}} Δ x = \frac{2 π}{{p}_{2}} {L}_{2} ϕ & ( 15 )\end{matrix}$$

Therefore, when the phase deviation amount ψ of a signal of each pixel 40 is calculated, the refraction angle φ is obtained from the equation (15) and a differential of the phase shift distribution Φ(x) is obtained by using the equation (14). Hence, by integrating the differential with respect to x, it is possible to generate the phase shift distribution Φ(x) of the photographic subject H, i.e., the phase contrast image of the photographic subject H. In the X-ray imaging system 10 of this illustrative embodiment, the phase deviation amount ψ is calculated by using a fringe scanning method that is described below.

In the fringe scanning method, an imaging is performed while one of the first and second absorption type gratings 31, 32 is stepwise translation-moved relatively to the other in the x direction (that is, an imaging is performed while changing the phases of the grating periods of both gratings). In the X-ray imaging system 10 of this illustrative embodiment, the second absorption type grating 32 is moved by the scanning mechanism 33. However, the first absorption type grating 31 may be moved. As the second absorption type grating 32 is moved, the moiré fringe is moved. When the translation distance (moving amount in the x direction) reaches one period (grating pitch p₂) of the grating period of the second absorption type grating 32 (i.e., when the phase change reaches 2π), the moiré fringe returns to its original position. Regarding the change of the moiré fringe, while moving the second absorption type grating 32 by 1/n (n: integer) with respect to the grating pitch p₂, the fringe images are captured by the FPD 30 and the signals of the respective pixels 40 are obtained from the captured fringe images and calculated in the calculation processing unit 22, so that the phase deviation amount ψ of the signal of each pixel 40 is obtained.

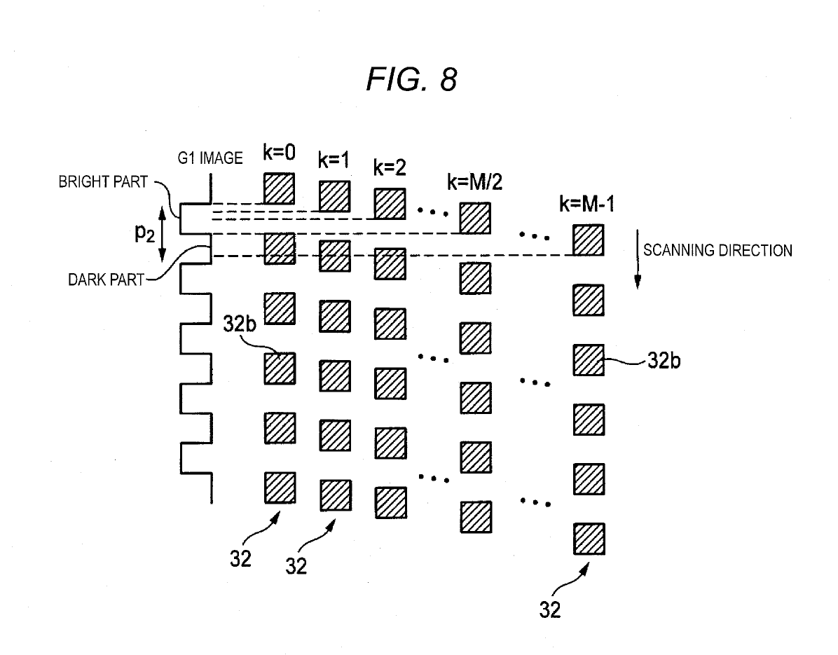

FIG. 8 pictorially shows that the second absorption type grating 32 is moved with a scanning pitch (p₂/M) (M: integer of 2 or larger) that is obtained by dividing the grating pitch p₂ into M.

The scanning mechanism 33 sequentially translation-moves the second absorption type grating 32 to each of M scanning positions of k=0, 1, 2, . . . , M−1. In FIG. 8, an initial position of the second absorption type grating 32 is a position (k=0) at which a dark part of the G1 image at the position of the second absorption type grating 32 when there is no photographic subject H substantially coincides with the X-ray shield unit 32b. However, the initial position may be any position of k=0, 1, 2, . . . , M−1.

First, at the position of k=0, mainly, the X-ray that is not refracted by the photographic subject H passes through the second absorption type grating 32. Then, when the second absorption type grating 32 is moved in order of k=1, 2, . . . , regarding the X-ray passing through the second absorption type grating 32, the component of the X-ray that is not refracted by the photographic subject H is decreased and the component of the X-ray that is refracted by the photographic subject H is increased. In particular, at the position of k=M/2, mainly, only the X-ray that is refracted by the photographic subject H passes through the second absorption type grating 32. At the position exceeding k=M/2, contrary to the above, regarding the X-ray passing through the second absorption type grating 32, the component of the X-ray that is refracted by the photographic subject H is decreased and the component of the X-ray that is not refracted by the photographic subject H is increased.

At each position of k=0, 1, 2, . . . , M−1, when the imaging is performed by the FPD 30, M signal values are obtained for the respective pixels 40. In the below, a method of calculating the phase deviation amount of the signal of each pixel 40 from the M signal values is described. When a signal value of each pixel 40 at the position k of the second absorption type grating 32 is indicated with Iₖ(x), Iₖ(x) is expressed by a following equation (16).

$$\begin{matrix}[ equation 16 ] & \\ {I}_{k} ( x ) = {A}_{0} + {\sum }_{n > 0} {A}_{n} exp [ 2 π i \frac{n}{{p}_{2}} \{ {L}_{2} ϕ ( x ) + \frac{{kp}_{2}}{M} \} ] & ( 16 )\end{matrix}$$

Here, x is a coordinate of the pixel 40 in the x direction, A₀ is the intensity of the incident X-ray and Aₙ is a value corresponding to the contrast of the signal value of the pixel 40 (n is a positive integer). Also, φ(x) indicates the refraction angle φ as a function of the coordinate x of the pixel 40.

Then, when a following equation (17) is used, the refraction angle φ(x) is expressed by a following equation (18).

$$\begin{matrix} [ equation 17 ] & \\ {\sum }_{k = 0}^{M - 1} exp ( - 2 π i \frac{k}{M} ) = 0 & ( 17 ) \\ [ equation 18 ] & \\ ϕ ( x ) = \frac{\text{?}}{2 π {L}_{2}} arg [ {\sum }_{k = 0}^{M - 1} {I}_{k} ( x ) exp ( - 2 π i \frac{k}{M} ) ] \\ \text{?} \text{indicates text missing or illegible when filed} & ( 18 )\end{matrix}$$

Here, arg[ ] means the extraction of an angle of deviation and corresponds to the phase deviation amount ψ of the signal of each pixel 40. Therefore, from the M signal values obtained from the respective pixels 40, the phase deviation amount ψ of the signal of each pixel 40 is calculated based on the equation (18), so that the refraction angle φ(x) is acquired.

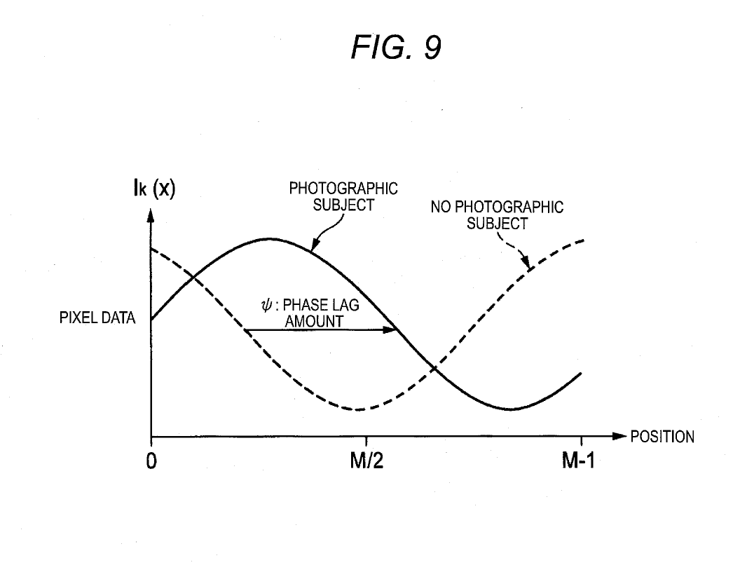

FIG. 9 shows a signal of one pixel of the radiological image detector, which is changed depending on the fringe scanning.

The M signal values obtained from the respective pixels 40 are periodically changed with the period of the grating pitch p₂ with respect to the position k of the second absorption type grating 32. The broken line of FIG. 9 indicates the change of the signal value when there is no photographic subject H and the solid line of FIG. 9 indicates the change of the signal value when there is the photographic subject H. A phase difference of both waveforms corresponds to the phase deviation amount ψ of the signal of each pixel 40.

Since the refraction angle φ(x) is a value corresponding to the differential phase value, as shown with the equation (14), the phase shift distribution Φ(x) is obtained by integrating the refraction angle φ(x) along the x axis. In the above descriptions, a y coordinate of the pixel 40 in the y direction is not considered. However, by performing the same calculation for each y coordinate, it is possible to obtain the two-dimensional phase shift distribution Φ(x, y) in the x and y directions.

The above calculations are performed by the calculation processing unit 22 and the calculation processing unit 22 stores the phase contrast image in the storage unit 23.

After the operator inputs the imaging instruction through the input device 21, the respective units operate in cooperation with each other under control of the control device 20, so that the fringe scanning and the generation process of the phase contrast image are automatically performed and the phase contrast image of the photographic subject H is finally displayed on the monitor 24.

In the below, the shutter unit 27 is described.

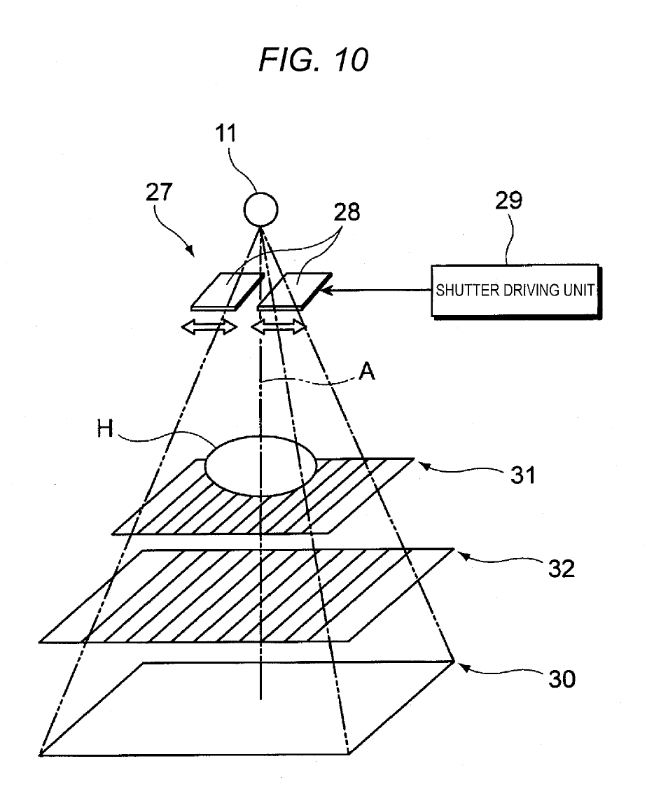

FIG. 10 schematically shows the configurations of the shutter unit 27 and the imaging unit. As shown, the shutter unit 27 has a pair of shield plates 28 that is movably supported by a slide mechanism (not shown) in a plane intersecting with the optical axis A of the X-ray, and a shutter driving unit 29 that slides the plates 28. As materials of the shield plates 28, materials having excellent X-ray absorption ability are preferable. For example, a member having heavy metal such as gold, platinum and the like formed on a substrate body by the metal plating or deposition method or a member having a heavy metal plate such as lead reinforced by a plate made of iron having high rigidity may be used.

The shield plates 28 are arranged so that surfaces of the shield plates 28 are substantially perpendicular to the optical axis A of the X-ray. The shutter driving unit 29 drives the shield plates 28 in arrow directions, respectively, thereby moving the same between an open position at which the traveling of the X-ray is allowed and a close position at which the traveling of the X-ray is shielded. In the meantime, the shield plates 28 may be configured so that one shield plate approaches and separates from the other shield plate.

The shutter driving unit 29 may use an appropriate driving mechanism such as a solenoid using an electromagnet, a mechanism having combined a motor and a gear, and the like. Based on an instruction from the X-ray source control unit 17 shown in FIG. 2, the shutter driving unit performs the opening and closing operations at a predetermined timing that is described in the below.

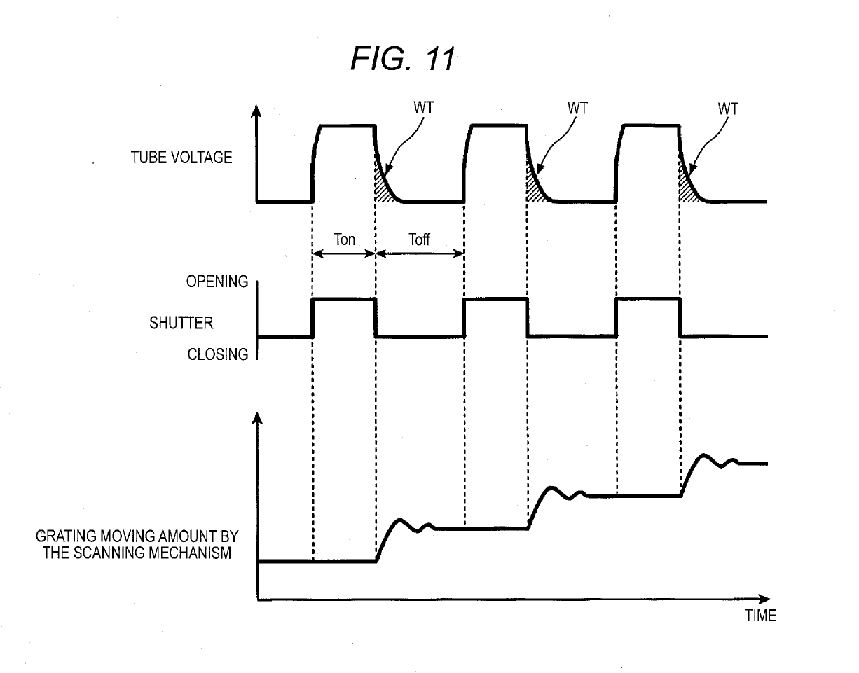

FIG. 11 illustrates a relation of a waveform of a tube voltage that is applied to the X-ray source 11, an opening and closing timing of the shutter unit 27 and a moving amount of a grating by the scanning mechanism 33.

When predetermined voltage and current are supplied to the X-ray source 11, the charges are accumulated in a cable connecting from the power supply unit to the X-ray tube, and the like. Due to the accumulated charges, when the voltage is dropped in applying the tube voltage of a pulse shape, the tube voltage becomes not zero instantaneously and is exponentially decreased as shown in FIG. 11, i.e., a so-called wave tail WT is generated.

When the wave tail WT is generated in the tube voltage waveform, the X-ray source 11 continuously outputs the X-ray without stopping the output of the X-ray in the period of the wave tail WT.

In the meantime, as described above, while the scanning mechanism 33 stepwise translation-moves one of the first and second absorption type gratings 31, 32 relatively to the other in the x direction, the FPD 30 performs the imaging at the positions of the respective moving destinations. At this time, the moving speed of the first and second absorption type gratings 31, 32 by the scanning mechanism 33 is exceedingly responsive at the time of the moving startup, so that the moving speed is not the constant speed.

Therefore, if the FPD 40 detects the X-ray by the wave tail at the time of rising at which the moving speed is excessively responsive, the change of the moiré by the difference of the distance between the first and second absorption type gratings 31, 32 being moving is more remarkably superimposed on the original moiré by the phase difference/refractive index difference. Thereby, when generating the phase contrast image, a calculation error is caused in the calculation process of the captured fringe images. As a result, the contrast or resolution is lowered, the artifact in which the variation of the moiré fringe cannot be perfectly removed or unstable non-uniformity is generated is caused, or only a phase contrast image whose diagnosis ability is remarkably low is obtained.

Therefore, according to the X-ray imaging system of this illustrative embodiment, in order to remove the influence of the wave tail WT of the tube voltage waveform, during a time period T_{ON} from timing at which the tube voltage increases to timing at which the tube voltage starts to decrease, the shield plates 28 of the shutter unit 27 are opened to enable the X-ray to pass therethrough, and during a time period T_{OFF} from timing at which the tube voltage decreases to timing at which the tube voltage starts to increase next time, the shield plates 28 are closed to block the X-ray. Thereby, during the time period T_{OFF} in which the X-ray by the wave tail WT is generated, the output from the X-ray source 11 is securely shielded by the shutter unit 27. Thus, the X-ray is not detected in the FPD 30, so that it is possible to prevent the wave tail WT from having an effect on the captured image.

After the shield plates of the shutter unit 27 are moved to the close position and thus shield the X-ray to be irradiated to the first absorption type grating 31, at least one of the first and second absorption type gratings 31, 32 is displaced relatively to the other. Accordingly, the relative displacement of the first and second absorption type gratings 31, 32 is made only during the shield period of the X-ray and the imaging by the FPD 30 is not performed at the timing at which the moving speed of the displacement is excessively responsive and thus the moiré is highly in disorder. As a result, it is possible to detect the primary moiré fringe accurately and stably.

Here, it is preferable to control the driving of the shutter unit 27 and the scanning mechanism 33 synchronously with the X-ray source driving signal with which the X-ray source control unit 17 (refer to FIG. 2) controls the output of the X-ray source 11.

The X-ray source control unit 17 outputs a timing signal to the high voltage generator 16 so as to irradiate the X-ray from the X-ray tube 18 at the desired timing, based on the instruction from the control device 20, and the high voltage generator 16 receives the timing signal and outputs a driving signal of the tube voltage waveform (which does not include a wave tail) shown in FIG. 11 to the X-ray tube 18. Thus, based on the timing signal output from the X-ray source control unit 17, a driving signal for opening and closing the shutter and a driving signal of the scanning mechanism 33 are generated.

Thereby, it is possible to accurately synchronize the X-ray source 11, the shutter unit 27 and the scanning mechanism 33, respectively, thereby driving the same in high control responsiveness. In the meantime, although the shutter unit 27 can generate the driving signal of the shutter unit 27 and the scanning mechanism 33 can generate the driving signal of the scanning mechanism 33, the X-ray source control unit 17 may generate the driving signals.

Also, when acquiring the captured image, it is preferable to synchronize the charge readout operation of the FPD 30 and the shutter opening and closing operation of the shutter unit 27. In this case, the driving signal of the shutter unit 27 is input to the scanning circuit 42 (refer to FIG. 3) of the FPD 30. Then, the scanning circuit 42 may set the shutter opening period of the shutter unit 27 as a light receiving period and set the charge readout timing based on the timing from the shutter opening to the shutter closing, thereby controlling the driving of the FPD 30.

In the meantime, as described above, the output of the X-ray source 11 may be a pulse shape. However, it is preferable to continuously irradiate the X-ray and to thus control the irradiation of the X-ray by controlling the opening and closing of the shutter unit 27 because the non-uniformity of the radiation doses is difficult to occur between the respective irradiations.

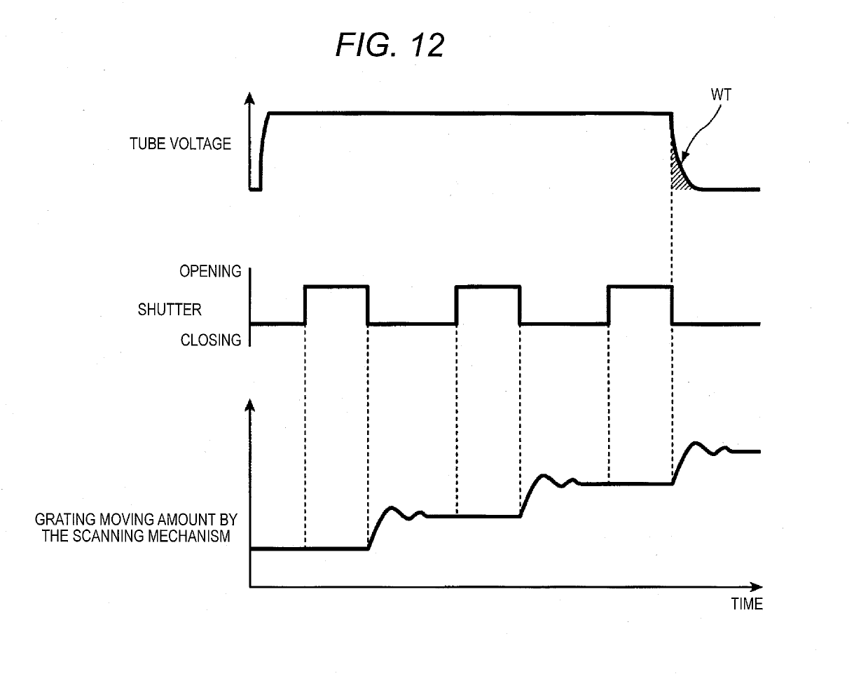

FIG. 12 illustrates a relation of a waveform of a tube voltage that is applied to the X-ray source 11 when the X-ray is continuously irradiated, an opening and closing timing of the shutter unit 27 and a moving amount of a grating by the scanning mechanism 33.

As shown in FIG. 12, the opening and closing driving of the shutter is performed several times in the ON output period of the X-ray source 11 that continuously irradiates the X-ray, so that the scanning mechanism 33 stops the moving of the grating during the shutter opening period and moves the grating during the shutter closing period. Thereby, it is possible to exclude the non-uniformity or instability of the excessive output responsiveness at the start of the X-ray irradiation, so that it is possible to easily keep the constant radiation dose without relying on an automatic exposure controller (AEC). Also, since the shutter is closed just after the output of the X-ray source 11 is off, the captured image is not influenced by the wave tail of the tube voltage waveform.

In the below, another example of the configuration of the shutter unit 27 is described.

The shutter unit 27 may rotate a circular shield plate having an opening, rather than the above way of opening and closing the shield plate.

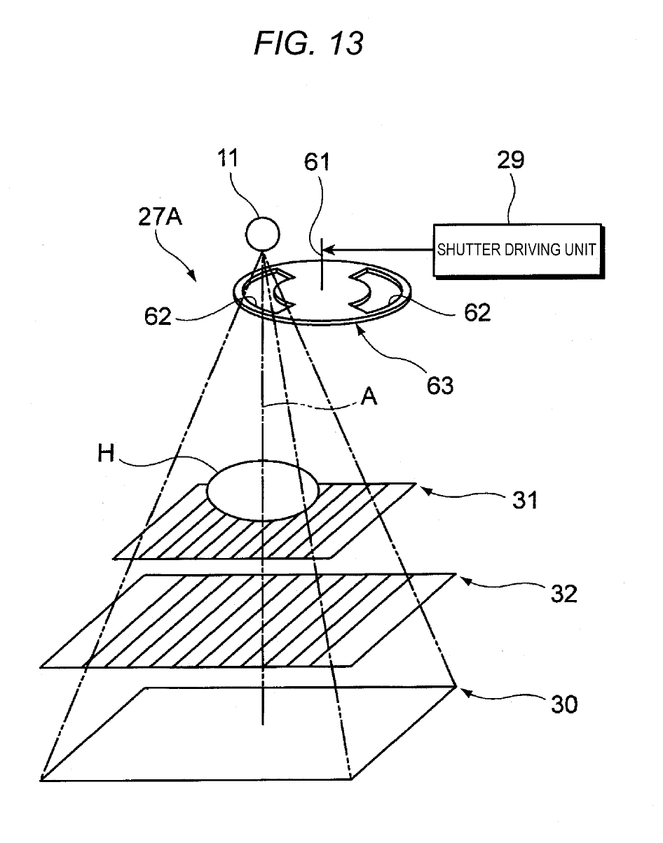

FIG. 13 shows a schematic configuration of a shutter unit 27A and the imaging unit. The shutter unit 27A includes a circular shield plate 63 having a radiation shield ability that is rotatably supported to a rotational shaft 61 and has openings 62 formed at parts along a circumferential direction and a shutter driving unit 29 that rotates the circular shield plate 63. The shutter driving unit 29 rotates the circular shield plate 63 and enables the radiation to pass through the circular shield plate or shields the radiation at an open position at which the traveling of the X-ray is allowed by the openings 62 or at a close position at which the traveling of the X-ray is shielded by a surface of the circular shield plate 63, thereby opening and closing the shutter.

Based on the driving signal of the X-ray source 11, the shutter driving unit 29 preferably synchronizes the on and off timings of the X-ray output and the opening and closing timings of the shutter so as to synchronize with the X-ray irradiation timing to the imaging unit. Like this, by acquiring the on and off timings of the X-ray output from the driving signal of driving the X-ray source 11, the shutter driving unit 29 can accurately drive the shutter in high responsiveness such as several ms order or smaller, so that it is possible to exclude the influence of the wave tails more securely.

As described above, according to the X-ray imaging system 10, the shield plates 28 (circular shield plate 63) that are the shutters and the shutter unit 27 (27A) having the shutter driving unit 29 for opening and closing the shutters are provided in the middle of the light path of the X-ray toward the imaging unit 12. At least one of the first absorption type grating 31 and the second absorption type grating 32 is displaced relatively to the other only in the period during which the shutters are closed to shield the radiation to be irradiated to the imaging unit 12. Thus, it is possible to remove the influence of the wave tail of the tube voltage waveform.

That is, even when the X-ray by the wave tail of the tube voltage waveform is output, the shutters are closed at the time of outputting the X-ray by the wave tail, so that the FDP 30 does not detect the X-ray. In addition, since the first absorption type grating 31 and the second absorption type grating 32 are displaced relatively to each other only in the period during which the shutters are closed and the X-ray is thus shielded, the FPD 30 does not perform the imaging when the moving speed is excessively responsive.

Therefore, the influence by the wave tail does not occur in the moiré fringe of the captured image, so that the phase contrast image obtained by the calculation processing has the high contrast and resolution and the image quality appropriate to the diagnosis.

Also, according to the X-ray imaging system 10, after the FPD completes the imaging by relatively moving the first and second absorption type gratings 31, 32, it is possible to initiate the relative moving to a next moving destination without waiting for the natural convergence of the wave tail. Accordingly, it is possible to complete the plurality of imaging in a short time, so that it is possible to suppress the shaking problem caused due to the moving of the patient to the minimum.

Also, according to the X-ray imaging system 10, the X-ray is not mostly diffracted at the first absorption type grating 31 and is geometrically projected to the second absorption type grating 32. Accordingly, it is not necessary for the irradiated X-ray to have high spatial coherence and thus it is possible to use a general X-ray source that is used in the medical fields, as the X-ray source 11. In the meantime, since it is possible to arbitrarily set the distance L₂ from the first absorption type grating 31 to the second absorption type grating 32 and to set the distance L₂ to be smaller than the minimum Talbot interference distance of the Talbot interferometer, it is possible to miniaturize the imaging unit 12. Further, in the X-ray imaging system of this illustrative embodiment, since the substantially entire wavelength components of the irradiated X-ray contribute to the projection image (G1 image) from the first absorption type grating 31 and the contrast of the moiré fringe is thus improved, it is possible to improve the detection sensitivity of the phase contrast image.

Also, in the X-ray imaging system 10, the refraction angle φ is calculated by performing the fringe scanning for the projection image of the first grating. Thus, it has been described that both the first and second gratings are the absorption type gratings. However, the invention is not limited thereto. As described above, the invention is also useful even when the refraction angle φ is calculated by performing the fringe scanning for the Talbot interference image. Accordingly, the first grating is not limited to the absorption type grating and may be a phase type grating. Also, the analysis method of the moiré fringe that is formed by the superimposition of the X-ray image of the first grating and the second grating is not limited to the above fringe scanning method. For example, a variety of methods using the moiré fringe, such as method of using Fourier transform/inverse Fourier transform known in “J. Opt. Soc. Am. Vol. 72, No. 1 (1982) p. 156”, may be also applied.

Also, it has been described that the X-ray imaging system 10 stores or displays, as the phase contrast image, the image based on the phase shift distribution Φ. However, as described above, the phase shift distribution Φ is obtained by integrating the differential of the phase shift distribution Φ obtained from the refraction angle φ, and the refraction angle φ and the differential of the phase shift distribution Φ are also related to the phase change of the X-ray by the photographic subject. Accordingly, the image based on the refraction angle φ and the image based on the differential of the phase shift distribution Φ are also included in the phase contrast image.

In addition, it may be possible to prepare a phase differential image (differential amount of the phase shift distribution Φ) from an image group that is acquired by performing the imaging (pre-imaging) at a state in which there is no photographic subject. The phase differential image reflects the phase non-uniformity of a detection system (that is, the phase differential image includes a phase deviation by the moiré, a grid non-uniformity, a refraction of a radiation dose detector, and the like). Also, by preparing a phase differential image from an image group that is acquired by performing the imaging (main imaging) at a state in which there is a photographic subject and subtracting the phase differential image acquired in the pre-imaging from the phase differential image acquired in the main imaging, it is possible to acquire a phase differential image in which the phase non-uniformity of a measuring system is corrected.

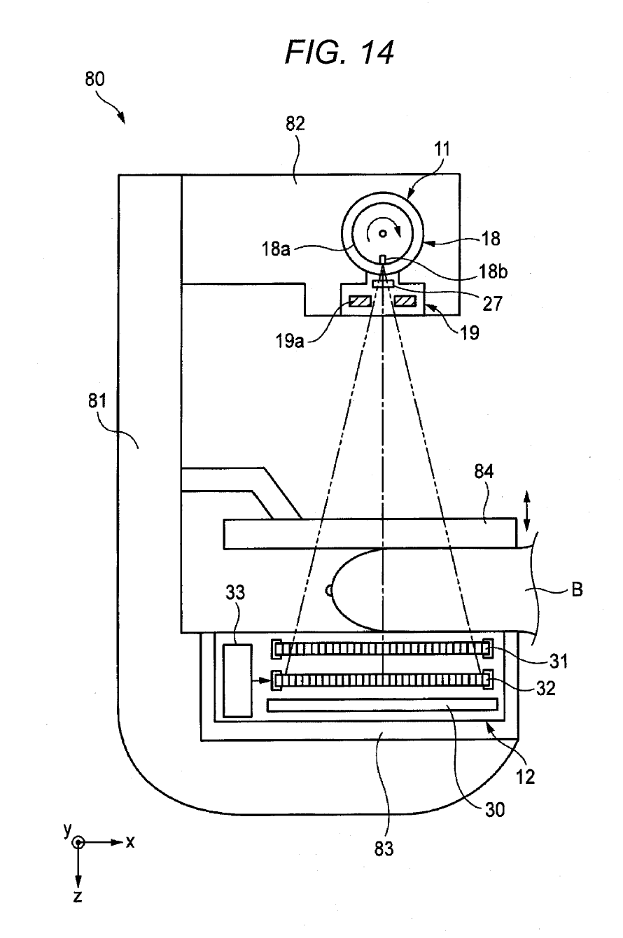

FIG. 14 shows another example of the radiographic system for illustrating an illustrative embodiment of the invention.

A mammography apparatus 80 shown in FIG. 14 is an apparatus of capturing an X-ray image (phase contrast image) of a breast B that is the photographic subject. The mammography apparatus 80 includes an X-ray source accommodation unit 82 that is mounted to one end of an arm member 81 rotatably connected to a base platform (not shown), an imaging platform 83 that is mounted to the other end of the arm member 81 and a pressing plate 84 that is configured to vertically move relatively to the imaging platform 83.

The X-ray source 11 is accommodated in the X-ray source accommodation unit 82 and the imaging unit 12 is accommodated in the imaging platform 83. The X-ray source 11 and the imaging unit 12 are arranged to face each other. The pressing plate 84 is moved by a moving mechanism (not shown) and presses the breast B between the pressing plate and the imaging platform 83. At this pressing state, the X-ray imaging is performed.

Also, the collimator unit 19 is provided with the shutter unit 27, as described above, and the configurations of the X-ray source 11 and the imaging unit 12 are the same as those of the X-ray imaging system 10. Therefore, the respective constitutional elements are indicated with the same reference numerals as the X-ray imaging system 10. Since the other configurations and the operations are the same as the above, the descriptions thereof are also omitted.

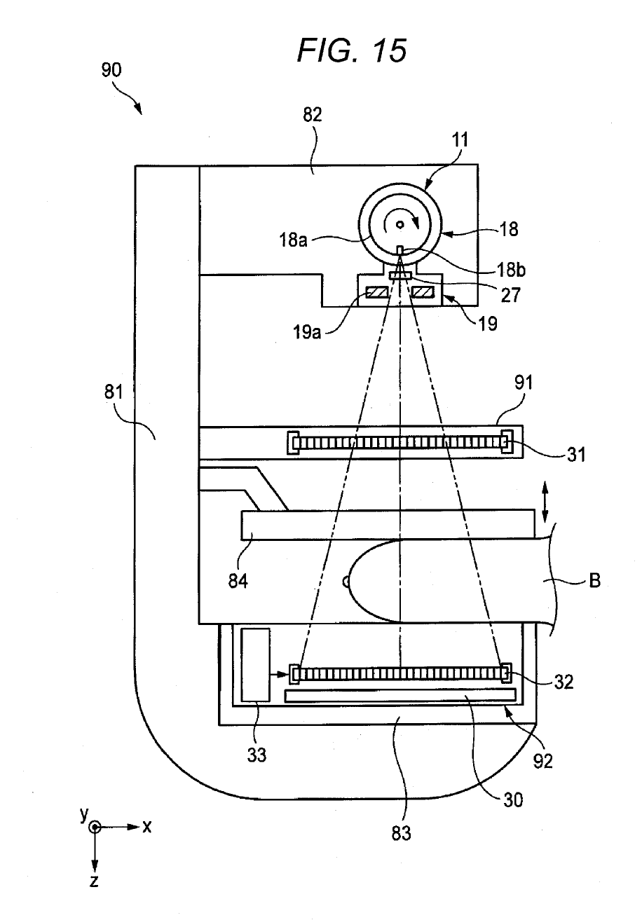

FIG. 15 shows a modified embodiment of the radiographic system of FIG. 14.

A mammography apparatus 90 shown in FIG. 15 is different from the mammography apparatus 80 in that the first absorption type grating 31 is provided between the X-ray source 11 and the pressing plate 84. The first absorption type grating 31 is accommodated in a grating accommodation unit 91 that is connected to the arm member 81. An imaging unit 92 is configured by the FPD 30, the second absorption type grating 32 and the scanning mechanism 33.

Like this, even when the object to be diagnosed (breast) B is positioned between the first absorption type grating 31 and the second absorption type grating 32, the projection image (G1 image) of the first absorption type grating 31, which is formed at the position of the second absorption type grating 32, is deformed by the object to be diagnosed B. Accordingly, also in this case, it is possible to detect the moiré fringe, which is modulated due to the object to be diagnosed B, by the FPD 30. That is, also with the mammography apparatus 90, it is possible to obtain the phase contrast image of the object to be diagnosed B by the above-described principle.

In the mammography apparatus 90, since the X-ray whose radiation dose has been substantially halved by the shielding of the first absorption type grating 31 is irradiated to the object to be diagnosed B, it is possible to decrease the radiation exposure amount of the object to be diagnosed B about by half, compared to the above mammography apparatus 80. In the meantime, like the mammography apparatus 90, the configuration in which the object to be diagnosed is arranged between the first absorption type grating 31 and the second absorption type grating 32 can be applied to the above X-ray imaging system 10.

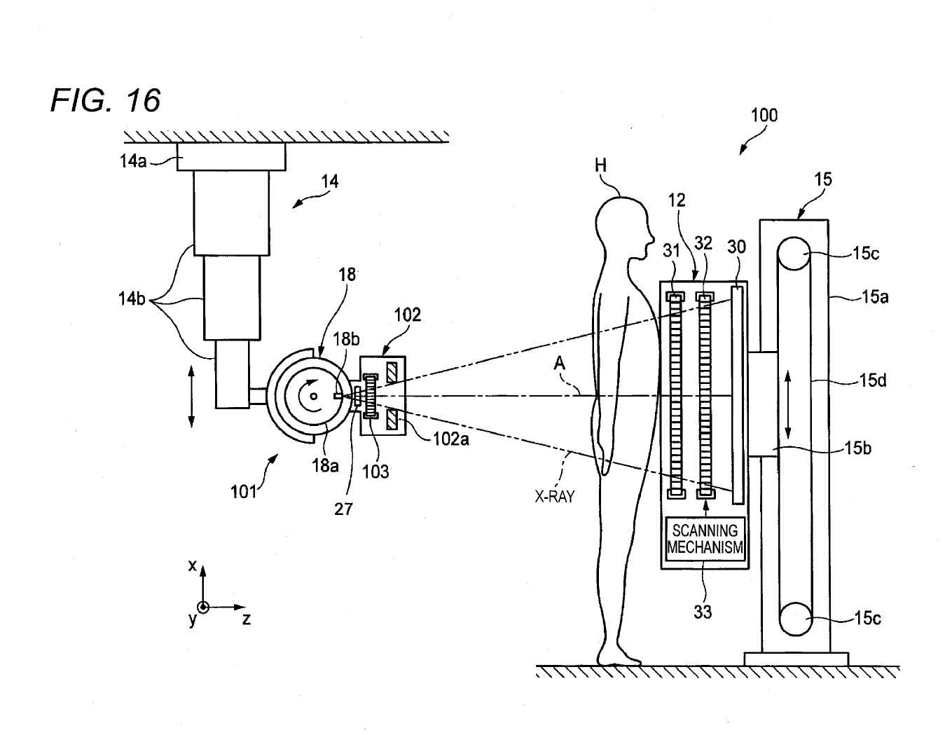

FIG. 16 shows another example of the radiographic system for illustrating an illustrative embodiment of the invention.

A radiographic system 100 is different from the radiographic system 10 in that a multi-slit 103 is provided to a collimator unit 102 of an X-ray source 101. Since the other configurations are the same as the above X-ray imaging system 10, the descriptions thereof are omitted.

In the above X-ray imaging system 10, when the distance from the X-ray source 11 to the FPD 30 is set to be same as a distance (1 to 2 m) that is set in an imaging room of a typical hospital, the blurring of the G1 image may be influenced by a focus size (in general, about 0.1 mm to 1 mm) of the X-ray focus point 18b, so that the quality of the phase contrast image may be deteriorated. Accordingly, it may be considered that a pin hole is provided just after the X-ray focus point 18b to effectively reduce the focus size. However, when an opening area of the pin hole is decreased so as to reduce the effective focus size, the X-ray intensity is lowered. In the X-ray imaging system 100 of this illustrative embodiment, in order to solve this problem, the multi-slit 103 is arranged just after the X-ray focus point 18b.

The multi-slit 103 is an absorption type grating (i.e., third absorption grating) having the same configuration as the first and second absorption type gratings 31, 32 provided to the imaging unit 12 and has a plurality of X-ray shield units extending in one direction (y direction, in this illustrative embodiment), which are periodically arranged in the same direction (x direction, in this illustrative embodiment) as the X-ray shield units 31b, 32b of the first and second absorption type gratings 31, 32. The multi-slit 103 is to partially shield the radiation emitted from the X-ray source 11, thereby reducing the effective focus size in the x direction and forming a plurality of point light sources (disperse light sources) in the x direction.

It is necessary to set a grating pitch p₃ of the multi-slit 103 so that it satisfies a following equation (19), when a distance from the multi-slit 103 to the first absorption type grating 31 is L₃.

$$\begin{matrix} [ equation 19 ] & \\ {p}_{3} = \frac{\text{?}}{\text{?}} {p}_{2} \\ \text{?} \text{indicates text missing or illegible when filed} & ( 19 )\end{matrix}$$

The equation (19) is a geometrical condition so that the projection images (G1 images) of the X-rays, which are emitted from the respective point light sources dispersedly formed by the multi-slit 103, by the first absorption type grating 31 coincide (overlap) at the position of the second absorption type grating 32.

Also, since the position of the multi-slit 103 is substantially the X-ray focus position, the grating pitch p₂ and the interval d₂ of the second absorption type grating 32 are determined to satisfy following equations (20) and (21).

$$\begin{matrix} [ equation 20 ] & \\ {p}_{2} = \frac{\text{?} + \text{?}}{\text{?}} {p}_{1} & ( 20 ) \\ [ equation 21 ] & \\ {d}_{2} = \frac{\text{?} + \text{?}}{\text{?}} {d}_{1} \\ \text{?} \text{indicates text missing or illegible when filed} & ( 21 )\end{matrix}$$

Like this, in the X-ray imaging system 100 of this illustrative embodiment, the G1 images based on the point light sources formed by the multi-slit 103 overlap, so that it is possible to improve the quality of the phase contrast image without lowering the X-ray intensity. The above multi-slit 103 can be applied to any of the X-ray imaging systems.

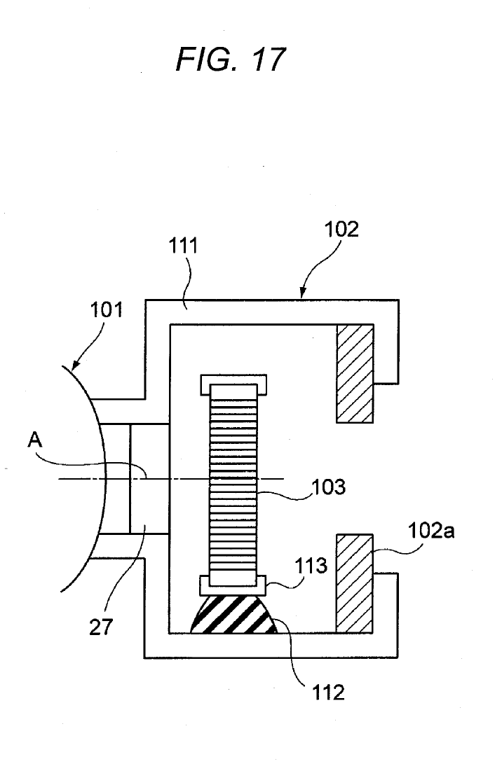

Meanwhile, as shown in FIG. 17, the shutter unit 27 is arranged at a side in the collimator unit 102, which faces toward the X-ray source 101 of the multi-slit 103. When the shutter unit 27 is arranged at a position closer to the multi-slit 103, it is possible to make a configuration favorable to the miniaturization and the high-speed driving because it is possible to make a size of the shutter smaller.

When the vibration is applied to the multi-slit 103, each of the formed point light sources vibrates and the effective focus size is thus increased, so that the blurring of the G1 image is enlarged. Like this, the multi-slit 103 is a member that disfavors the vibration, particularly, and thus it is necessary to suppress the vibration in the order of μm so as to obtain a radiological transmission image of high precision having the photographic subject interposed.

Accordingly, in this configuration, the multi-slit 103 is supported in a housing 111 of the collimator unit 102 via a buffer member 112, so that the vibration of the shutter unit 27, which is a generation source of the vibration, is prevented from being transferred to the multi-slit 103. The buffer member 112 may be provided between a support member 113 of the multi-slit 103 and the housing 111 or to a part at which the shutter unit 27 is supported to the housing 111 of the collimator unit 102. Also, when the buffer members are provided to both parts, the vibration-proof effect can be further improved.

The buffer member 112 is made of an elastic member having rubber elasticity such as rubber, resin and the like. In addition to this, the buffer member may consist of a member having a spring structure or an actuator having a buffer function. Also, the buffer member 112 may be provided to a side surface orthogonal to the optical axis A, in addition to the configuration in which the buffer member is provided to the lower surface of the support member 113 of the multi-slit 103 in the vertical direction. At this time, compared to a configuration in which the buffer members are provided on both opposing surfaces such as upper and lower surfaces and left and right surfaces, a configuration in which the buffer member is provided on only one side is preferable because the more favorable buffer effect is easily obtained.

As described above, when the shutter unit 27 and the multi-slit 103 are arranged with the vibration-proof structure having the buffer member 112 interposed therebetween in the housing 111 of the collimator unit 102, it is possible to stably support the multi-slit 103 with the vibration thereof being controlled, which contributes to the improvement on the phase detection accuracy.

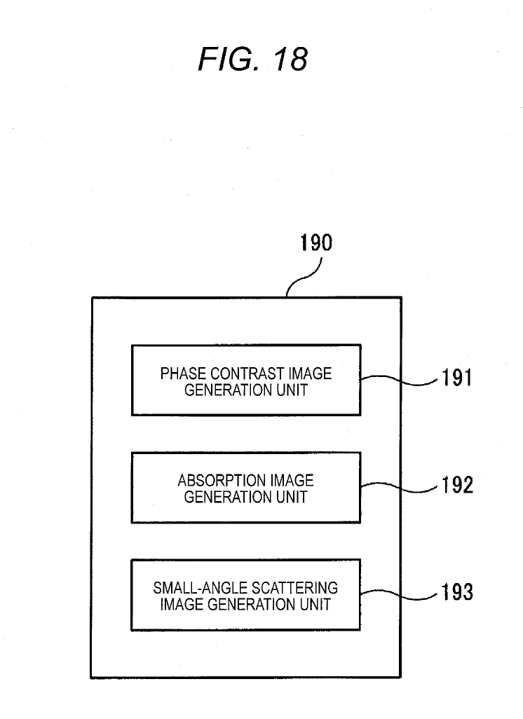

FIG. 18 shows another example of a radiographic system for illustrating an illustrative embodiment of the invention.

According to the respective X-ray imaging systems, it is possible to acquire a high contrast image (phase contrast image) of an X-ray weak absorption object that cannot be easily represented. Further, to refer to the absorption image in correspondence to the phase contrast image is helpful to the image reading. For example, it is effective to superimpose the absorption image and the phase contrast image by the appropriate processes such as weighting, gradation, frequency process and the like and to thus supplement a part, which cannot be represented by the absorption image, with the information of the phase contrast image. However, when the absorption image is captured separately from the phase contrast image, the capturing positions between the capturing of the phase contrast image and the capturing of the absorption image are deviated to make the favorable superimposition difficult. Also, the burden of the object to be diagnosed is increased as the number of the imaging is increased. In addition, in recent years, a small-angle scattering image attracts attention in addition to the phase contrast image and the absorption image. The small-angle scattering image can represent tissue characterization and state caused due to the fine structure in the photographic subject tissue. For example, in fields of cancers and circulatory diseases, the small-angle scattering image is expected as a representation method for a new image diagnosis.

Accordingly, the X-ray imaging system of this illustrative embodiment uses a calculation processing unit 190 that enables the absorption image and the small-angle scattering image to be generated from a plurality of images acquired for the phase contrast image. Since the other configurations are the same as the above X-ray imaging system 10, the descriptions thereof are omitted. The calculation processing unit 190 has a phase contrast image generation unit 191, an absorption image generation unit 192 and a small-angle scattering image generation unit 193. The units perform the calculation processes, based on the image data acquired at the M scanning positions of k=0, 1, 2, . . . , M−1. Among them, the phase contrast image generation unit 191 generates a phase contrast image in accordance with the above-described process.

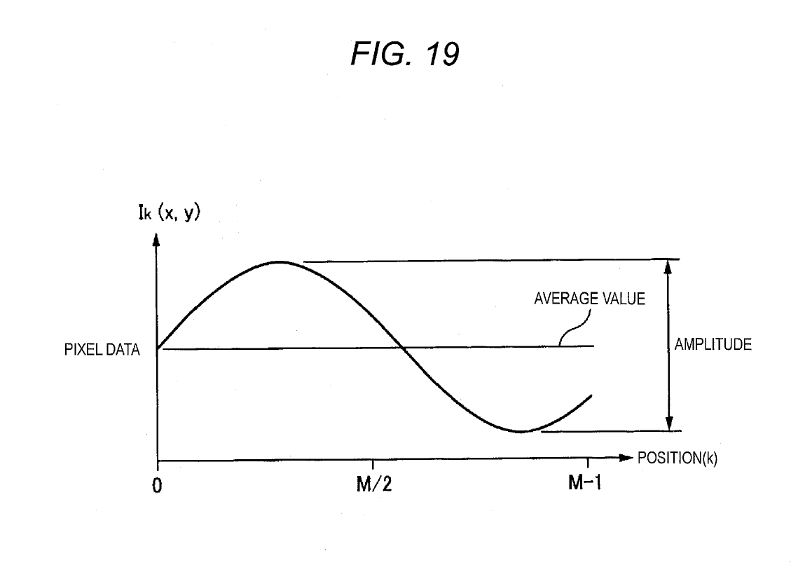

The absorption image generation unit 192 averages the image data Iₖ(x, y), which is obtained for each pixel, with respect to k, as shown in FIG. 19, and thus calculates an average value and images the image data, thereby generating an absorption image. Also, the calculation of the average value may be performed simply by averaging the image data Iₖ(x, y) with respect to k. However, when M is small, an error is increased. Accordingly, after fitting the image data Iₖ(x, y) with a sinusoidal wave, an average value of the fitted sinusoidal wave may be calculated. In addition, when generating the absorption image, the invention is not limited to the using of the average value. For example, an addition value that is obtained by adding the image data Iₖ(x, y) with respect to k may be used inasmuch as it corresponds to the average value.

In the meantime, it may be possible to prepare an absorption image from an image group that is acquired by performing the imaging (pre-imaging) at a state in which there is no photographic subject. The absorption image reflects a transmittance non-uniformity of a detection system (that is, the absorption image includes information such as a transmittance non-uniformity of grids, an absorption influence of a radiation dose detector, and the like). Therefore, from the image, it is possible to prepare a correction coefficient map for correcting the transmittance non-uniformity of the detection system. Also, by preparing an absorption image from an image group that is acquired by performing the imaging (main imaging) at a state in which there is a photographic subject and multiplying the respective pixels with the correction coefficient, it is possible to acquire an absorption image of the photographic subject in which the transmittance non-uniformity of the detection system is corrected.

The small-angle scattering image generation unit 193 calculates an amplitude value of the image data Iₖ(x, y), which is obtained for each pixel, and thus images the image data, thereby generating a small-angle scattering image. Meanwhile, the amplitude value may be calculated by calculating a difference between the maximum and minimum values of the image data Iₖ(x, y). However, when M is small, an error is increased. Accordingly, after fitting the image data Iₖ(x, y) with a sinusoidal wave, an amplitude value of the fitted sinusoidal wave may be calculated. In addition, when generating the small-angle scattering image, the invention is not limited to the using of the amplitude value. For example, a variance value, a standard error and the like may be used as an amount corresponding to the non-uniformity about the average value.

In the meantime, it may be possible to prepare a small-angle scattering image from the image group that is acquired by performing the imaging (pre-imaging) at a state in which there is no photographic subject. The small-angle scattering image reflects amplitude value non-uniformity of a detection system (that is, the small-angle scattering image includes information such as pitch non-uniformity of grids, opening ratio non-uniformity, non-uniformity due to the relative position deviation between the grids, and the like). Therefore, from the image, it is possible to prepare a correction coefficient map for correcting the amplitude value non-uniformity of the detection system. Also, by preparing a small-angle scattering image from an image group that is acquired by performing the imaging (main imaging) at a state in which there is a photographic subject and multiplying the respective pixels with the correction coefficient, it is possible to acquire a small-angle scattering image of the photographic subject in which the amplitude value non-uniformity of the detection system is corrected.

According to the X-ray imaging system of this illustrative embodiment, the absorption image or small-angle scattering image is generated from the plurality of images acquired for the phase contrast image of the photographic subject. Accordingly, the capturing positions between the capturing of the phase contrast image and the capturing of the absorption image are not deviated, so that it is possible to favorably superimpose the phase contrast image and the absorption image or small-angle scattering image. Also, it is possible to reduce the burden of the photographic subject, compared to a configuration in which the imaging is separately performed so as to acquire the absorption image and the small-angle scattering image.

As described above, the specification discloses a radiological image detection apparatus that includes a first grating, a second grating, a scanning unit, a radiological image detector, a shutter and a shutter driving unit. The second grating includes a period which substantially coincides with a pattern period of a radiological image formed by the radiation passing through the first grating. The scanning unit relatively displaces the radiological image and the second grating to a plurality of relative positions at which phase differences between the radiological image and the second grating are different from each other. The radiological image detector detects the radiological image masked by the second grating. The shutter is provided in a middle of a light path of the radiation toward the first grating. The shutter driving unit opens and closes the shutter. The scanning unit displaces at least one of the first grating and the second grating relatively to the other only in a period during which the shutter is closed to shield the radiation to be irradiated to the first grating.

Also, according to the radiological image detection apparatus disclosed in the specification, the radiological image detection apparatus further includes a radiation source control unit. The radiation source control unit outputs a radiation source driving signal including a steep dropping driving pattern to a radiation source outputting the radiation. The shutter driving unit closes the shutter at least just after an output of the radiation source is switched from on to off by the radiation source control unit.

Also, according to the radiological image detection apparatus disclosed in the specification, the shutter driving unit performs a plurality of operations of opening and closing the shutter in a period during which the output of the radiation source is continuously on.

Also, according to the radiological image detection apparatus disclosed in the specification, the shutter driving unit opens and closes the shutter synchronously with the radiation source driving signal which enables the radiation source to output the radiation.

Also, according to the radiological image detection apparatus disclosed in the specification, the shutter has a shield plate which is movably supported in a plane intersecting with an optical axis of the radiation and which has a radiation shield ability. The shutter driving unit advances and retreats the shield plate between an open position at which the radiation is enabled to pass and a close position at which the passing of the radiation is shielded.

Also, according to the radiological image detection apparatus disclosed in the specification, the shutter has a circular shield plate which is rotatably supported and which has an opening formed at a part along a circumferential direction thereof and a radiation shield ability. The shutter driving unit rotates the circular shield plate to enable the radiation to pass through the opening or to shield the radiation by rotating the circular shield plate.

Also, according to the radiological image detection apparatus disclosed in the specification, the radiological image detection apparatus further includes a third grating. The third grating enables the irradiated radiation to selectively pass through an area of the third grating and that enables the passed radiation to irradiate to the first grating.

Also, according to the radiological image detection apparatus disclosed in the specification, the shutter is arranged at a radiation irradiation side of the third grating.

Also, according to the radiological image detection apparatus disclosed in the specification, a buffer member which attenuates vibration generated from the shutter is arranged between the third grating and the shutter.

Also, the specification discloses a radiographic apparatus including one of the radiological image detection apparatuses and a radiation source which irradiates the radiation to the radiological image detection apparatus.

Also, the specification discloses a radiographic system including the radiographic apparatus and a calculation processing unit. The calculation processing unit calculates, from an image detected by the radiological image detector of the radiographic apparatus, a refraction angle distribution of the radiation incident onto the radiological image detector and generates a phase contrast image of a photographic subject based on the refraction angle distribution.

What is claimed is:

1. A radiological image detection apparatus comprising:
a first grating;
a second grating that includes a period which substantially coincides with a pattern period of a radiological image formed by the radiation passing through the first grating;
a scanning unit that relatively displaces the radiological image and the second grating to a plurality of relative positions at which phase differences between the radiological image and the second grating are different from each other;
a radiological image detector that detects the radiological image masked by the second grating;
a shutter that is provided in a middle of a light path of the radiation toward the first grating; and
a shutter driving unit that opens and closes the shutter,
wherein the scanning unit displaces at least one of the first grating and the second grating relatively to the other only in a period during which the shutter is closed to shield the radiation to be irradiated to the first grating.

2. The radiological image detection apparatus according to claim 1, further comprising:
a radiation source control unit that outputs a radiation source driving signal including a steep dropping driving pattern to a radiation source outputting the radiation,
wherein the shutter driving unit closes the shutter at least just after an output of the radiation source is switched from on to off by the radiation source control unit.

3. The radiological image detection apparatus according to claim 2,
wherein the shutter driving unit performs a plurality of operations of opening and closing the shutter in a period during which the output of the radiation source is continuously on.

4. The radiological image detection apparatus according to claim 1,
wherein the shutter driving unit opens and closes the shutter synchronously with the radiation source driving signal which enables the radiation source to output the radiation.

5. The radiological image detection apparatus according to claim 1,
wherein the shutter has a shield plate which is movably supported in a plane intersecting with an optical axis of the radiation and which has a radiation shield ability, and
the shutter driving unit advances and retreats the shield plate between an open position at which the radiation is enabled to pass and a close position at which the passing of the radiation is shielded.

6. The radiological image detection apparatus according to claim 1,
wherein the shutter has a circular shield plate which is rotatably supported and which has an opening formed at a part along a circumferential direction thereof and a radiation shield ability, and
the shutter driving unit rotates the circular shield plate to enable the radiation to pass through the opening or to shield the radiation by rotating the circular shield plate.

7. The radiological image detection apparatus according to claim 1, further comprising:
a third grating that enables the irradiated radiation to selectively pass through an area of the third grating and that enables the passed radiation to irradiate to the first grating.

8. The radiological image detection apparatus according to claim 7,
wherein the shutter is arranged at a radiation irradiation side of the third grating.

9. The radiological image detection apparatus according to claim 8,
wherein a buffer member which attenuates vibration generated from the shutter is arranged between the third grating and the shutter.

10. A radiographic apparatus comprising:
the radiological image detection apparatus according to claim 1; and
a radiation source that irradiates the radiation to the radiological image detection apparatus.

11. A radiographic system comprising:
the radiographic apparatus according to claim 10; and
a calculation processing unit that calculates, from an image detected by the radiological image detector of the radiographic apparatus, a refraction angle distribution of the radiation incident onto the radiological image detector and that generates a phase contrast image of a photographic subject based on the refraction angle distribution.
